(19) United States
(12) Patent Application Publication
(10) Pub. No.: US 2026/0229134 A1
(43) Pub. Date: Aug. 6, 2026

(54) COLLISION DETECTION METHOD AND APPARATUS, DEVICE, MEDIUM, AND PROGRAM PRODUCT

(71) Applicant: Tencent Technology (Shenzhen) Company Limited, Shenzhen (CN)

(72) Inventor: Haining DU, Shenzhen (CN)

(73) Assignee: Tencent Technology (Shenzhen) Company Limited, Shenzhen (CN)

(21) Appl. No.: 19/632,491

(22) Filed: Mar. 30, 2026

Related U.S. Application Data
(63) Continuation of application No. PCT/CN2024/118718, filed on Sep. 13, 2024.

(30) Foreign Application Priority Data
Nov. 29, 2023 (CN) 202311627124.8

(51) Int. Cl. G08G 9/02

(52) U.S. Cl. CPC G08G 9/02

(57) ABSTRACT

A collision detection method performed by a computer device includes acquiring track information of a first movable device; constructing, for each of the first plurality of timestamps, a first three-dimensional spatial structure corresponding to the respective timestamp based on the position information of the first movable device at the respective timestamp and the physical size information of the first movable device; acquiring existing track information of a second movable device based on collision detection of the second moveable device being completed to indicate that no collision is predicted to occur; performing, using a collision detection policy, collision detection to obtain a collision detection result corresponding to the same timestamp; generating a collision detection feedback result of the first movable device based on a collision detection result.

### CROSS-REFERENCE TO RELATED APPLICATIONS

This application is a bypass continuation application of International Patent Application No. PCT/CN2024/118718, filed on Sep. 13, 2024, which claims priority to and is based on Chinese Patent Application No. 202311627124.8, filed on Nov. 29, 2023 and entitled “COLLISION DETECTION METHOD AND APPARATUS, DEVICE, MEDIUM, AND PROGRAM PRODUCT,” the disclosures of which are incorporated herein in their entireties by reference.

### FIELD

The present disclosure relates to the technical field of computers, and in particular, to a collision detection method, a collision detection apparatus, a computer device, a computer-readable storage medium, and a computer program product.

### BACKGROUND

With the rapid rise of intelligent traffic, various movable devices are rapidly developed, and the movable devices are applied to different application fields with advantages such as danger resistance and flexibility.

Practical experience shows that movable devices are prone to collisions during operation. For example, when two movable devices are close to each other during operation, the motion of one movable device may negatively affect the other. Therefore, detecting a collision problem during the operation of movable platforms can be improved.

### SUMMARY

Some embodiments of the present disclosure provide a collision detection method and apparatus, a device, a medium, and a program product, which can effectively improve the accuracy of collision detection for a movable device.

Some embodiments provide a collision detection method that is performed by a computer device. The collision detection method includes acquiring track information of a first movable device, the track information including: a first plurality of timestamps within a first track time period of the first movable device, position information of the first movable device at each of the first plurality of timestamps, and physical size information of the first movable device; constructing, for each of the first plurality of timestamps, a first three-dimensional spatial structure corresponding to the respective timestamp based on the position information of the first movable device at the respective timestamp and the physical size information of the first movable device; acquiring existing track information of a second movable device based on collision detection of the second moveable device being completed to indicate that no collision is predicted to occur. The existing track information includes: a second plurality of timestamps within a second track time period of the second movable device; and a second three-dimensional spatial structure corresponding to each of the second plurality of timestamps, the second three-dimensional spatial structure being a three-dimensional spatial structure constructed based on physical size information of the second movable device, and an interference distance and an operating range of the second movable device at a timestamp corresponding to the second three-dimensional spatial structure. The collision detection method further includes performing, using a collision detection policy, collision detection based on the first three-dimensional spatial structure and the second three-dimensional spatial structure that correspond to a same timestamp, to obtain a collision detection result corresponding to the same timestamp; and generating a collision detection feedback result of the first movable device based on a collision detection result corresponding to each of the first plurality of timestamps.

Some embodiments provide a collision detection apparatus that includes at least one memory configured to store computer program code and at least one processor configured to read the program code and operate as instructed by the program code. The program code includes acquisition code configured to cause the at least one processor to acquire track information of a first movable device, the track information including: a first plurality of timestamps within a first track time period of the first movable device, position information of the first movable device at each of the first plurality of timestamps, and physical size information of the first movable device. The program code further includes processing code configured to cause the at least one processor to construct, for each of the first plurality of timestamps, a first three-dimensional spatial structure corresponding to the respective timestamp based on the position information of the first movable device at the respective timestamp and the physical size information of the first movable device; acquire existing track information of a second movable device based on collision detection of the second moveable device being completed to indicate that no collision is predicted to occur; perform, using a collision detection policy, collision detection based on the first three-dimensional spatial structure and the second three-dimensional spatial structure that correspond to a same timestamp, to obtain a collision detection result corresponding to the same timestamp; and generate a collision detection feedback result of the first movable device based on a collision detection result corresponding to each of the first plurality of timestamps. The existing track information includes a second plurality of timestamps within a second track time period of the second movable device; and a second three-dimensional spatial structure corresponding to each of the second plurality of timestamps, the second three-dimensional spatial structure being a three-dimensional spatial structure constructed based on physical size information of the second movable device, and an interference distance and an operating range of the second movable device at a timestamp corresponding to the second three-dimensional spatial structure.

Some embodiments provide non-transitory computer-readable storage medium, storing computer code, when executed by at least one processor, causes the at least one processor to at least acquire track information of a first movable device, the track information including: a first plurality of timestamps within a first track time period of the first movable device, position information of the first movable device at each of the first plurality of timestamps, and physical size information of the first movable device; construct, for each of the first plurality of timestamps, a first three-dimensional spatial structure corresponding to the respective timestamp based on the position information of the first movable device at the respective timestamp and the physical size information of the first movable device; acquire existing track information of a second movable device based on collision detection of the second moveable device being completed to indicate that no collision is predicted to occur; perform, using a collision detection policy, collision detection based on the first three-dimensional spatial structure and the second three-dimensional spatial structure that correspond to a same timestamp, to obtain a collision detection result corresponding to the same timestamp; and generate a collision detection feedback result of the first movable device based on a collision detection result corresponding to each of the first plurality of timestamps. The existing track information includes a second plurality of timestamps within a second track time period of the second movable device; and a second three-dimensional spatial structure corresponding to each of the second plurality of timestamps, the second three-dimensional spatial structure being a three-dimensional spatial structure constructed based on physical size information of the second movable device, and an interference distance and an operating range of the second movable device at a timestamp corresponding to the second three-dimensional spatial structure.

Details of some embodiments of the disclosure are provided in the accompanying drawings and descriptions below. Other features, objectives, and advantages of the disclosure become apparent from the disclosure.

### BRIEF DESCRIPTION OF DRAWINGS

To more clearly illustrate the technical solutions in embodiments of the disclosure or in conventional technology, the drawings required in the descriptions of some embodiments or the related art will be briefly introduced below. It is clear that the drawings described below are only embodiments of the disclosure, and a person skilled in the art may obtain other drawings according to the disclosed drawings without involving any creative effort.

FIG. 1 is a schematic architectural diagram of a collision detection system according to some embodiments of the disclosure.

FIG. 2 is a schematic flowchart of a collision detection method according to some embodiments of the disclosure.

FIG. 3 is a schematic diagram of a three-dimensional spatial structure according to some embodiments of the disclosure.

FIG. 4 is a schematic diagram of a core layer according to some embodiments of the disclosure.

FIG. 5 is a schematic diagram of a physical layer according to some embodiments of the disclosure.

FIG. 6 is a schematic diagram of another physical layer according to some embodiments of the disclosure.

FIG. 7 is a schematic diagram of an interference layer according to some embodiments of the disclosure.

FIG. 8 is a schematic flowchart of another collision detection method according to some embodiments of the disclosure.

FIG. 9 is a schematic backend flowchart of a collision detection according to some embodiments of the disclosure.

FIG. 10 is a schematic diagram of a track according to some embodiments of the disclosure.

FIG. 11 is a schematic diagram of a particle detection according to some embodiments of the disclosure.

FIG. 12 is a schematic structural diagram of a collision detection apparatus according to some embodiments of the disclosure.

FIG. 13 is a schematic structural diagram of a computer device according to some embodiments of the disclosure.

### DETAILED DESCRIPTION

One or more embodiments of the present disclosure will be described in detail with reference to the accompanying drawings. Specific configurations and details are provided to ensure thorough understanding of the implementation techniques. However, these techniques may be practiced in different configurations without such specifics. Well-known features may be omitted or simplified to avoid obscuring the described techniques.

The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features.

As used herein, an expression, “a and/or b” should be understood as including only a, only b and both a and b. As used herein, expressions “at least one of a, b, and c” and “at least one of a, b, or c” should be understood as including only a, only b, only c, both a and b, both a and c, both b and c, or all of a, b, and c.

Further, unless stated otherwise or otherwise clear from context, phrase “based on” may refer to “based at least in part on” and not “based solely on.”

The terms “first,” “second,” “third,” and the like in the description and in the claims, if any, are used for distinguishing between similar elements and not necessarily for describing a sequential or chronological order. It is to be understood that the terms so used are interchangeable under appropriate circumstances.

In the following descriptions, related “some embodiments” describe a subset of all possible embodiments. However, it may be understood that the “some embodiments” may be the same subset or different subsets of all the possible embodiments, and may be combined with each other without conflict.

In some embodiments of the disclosure, a collision detection solution based on a movable device is proposed. The movable device, alternatively referred to as a movable platform or the like, is a device having a movement or motion capability, and is specifically a device that can move according to a planned path according to a control instruction. The control instruction herein may be directly or indirectly transmitted by an object (e.g., a user that holds or controls the movable device) to the movable device, or may be a preset program, so that the movable device may automatically move based on the preset program. The movable device may include, but is not limited to, an aircraft, an intelligent robot, a vehicle, or a ship. An aircraft is a device capable of operating in the air. Common aircraft include an unmanned aerial vehicle, an airplane, an airship, or the like. The intelligent robot may refer to a device having a movement capability, for example, a robot that may move according to a given path in a hotel or a shopping mall to provide a service to an object. A vehicle may be an autonomous vehicle (e.g., realizing autonomous driving according to a preset program of an object). Such an autonomous vehicle does not require direct user control over vehicle movement, and therefore may alternatively be referred to as an unmanned vehicle or the like. The ship may refer to an autonomous ship, an unmanned ship, or the like.

Further, collision detection, alternatively referred to as anti-collision detection, refers to a mechanism for detecting whether a movable device collides with an obstacle during motion. The obstacle herein may include, but is not limited to, another movable device, an animal, or a static object. For a movable device, accurate recognition or detection of various collision situations along its operational motion path is an important factor for ensuring safe movement of the movable device. For example, during an aerial operation, if the unmanned aerial vehicle fails to effectively avoid an obstacle in its operational path, problems such as crashes caused by a collision between the unmanned aerial vehicle and the obstacle may occur.

Considering the wide application of the unmanned aerial vehicle to various fields, the unmanned aerial vehicle has become a global research hotspot. Therefore, in some embodiments of the disclosure, an example in which the movable device is an unmanned aerial vehicle is used subsequently to describe the collision detection solution proposed in some embodiments of the disclosure. The collision detection solution provided in some embodiments of the disclosure may be extended to collision detection of other movable devices except an aircraft.

To improve the accuracy of collision detection of a movable device during operation and reduce the calculation overhead of the collision detection, in the collision detection solution provided in some embodiments of the disclosure, a concept of a three-layer spatiotemporal capsule is provided, aiming to extend track planning (or plan) of a movable platform to a three-dimensional spatial structure that considers a physical size of the movable device and surrounding interference. In addition, a collision detection policy is introduced. The policy can check, through quick particle check and extremum check, whether a collision conflict occurs between a to-be-detected track of a to-be-detected movable device and an existing track of a detected movable device, so that the number of times of detection can be greatly reduced while ensuring that a potential track planning conflict is detected, thereby greatly improving the detection efficiency. The track planning for the movable device refers to an optimal flight track from a start point to a target point that is planned for the movable platform and that satisfies some performance indicators under particular constraint conditions. In short, the track planning for the movable device may be an optimal flight path that is set for the movable device under particular constraint conditions by an object that controls the movable device. Information such as a heading angle, a speed, and a three-dimensional position of the movable device in a time dimension is mainly considered during track planning, and an output result obtained during the track planning is position information of the movable device at each of a plurality of timestamps within a track time period. The track time period is alternatively referred to as a takeoff and landing time period (e.g., a flight time period between a moment at which the movable device starts to fly from the start point and a moment at which the movable device ends flying at the target point). The timestamp is alternatively referred to as a time step (for example, each second). The position information may be regarded as a position point.

Specifically, a general procedure of the collision detection solution provided in some embodiments of the disclosure may include the following operations. Assuming that a first movable device has a collision detection requirement, to-be-detected track information of the first movable device may be acquired. The to-be-detected track information includes a plurality of timestamps within a first track time period of the first movable device, position information of the first movable device at each of the timestamps, and physical size information of the first movable device. After the to-be-detected track information of the first movable device is acquired, a first three-dimensional spatial structure (e.g., the three-layer spatiotemporal capsule mentioned above) corresponding to each of the timestamps may be constructed for the first movable device based on the position information at each of the timestamps and the physical size information that are included in the to-be-detected track information. The first three-dimensional spatial structure is a three-dimensional spatial structure (for example, a cuboid) that encompasses all spatial positions that the first movable device can reach at a corresponding timestamp when the physical size information of the first movable device and an interference distance of an ambient environment are considered. Then, existing track information of a detected second movable device (e.g., collision detection is performed on the track planning for the second movable device during operation, and a collision detection result is that no collision is predicted to occur) is acquired. The existing track information includes at least a second three-dimensional spatial structure corresponding to the second movable device at each of the timestamps. Finally, using the collision detection policy designed in some embodiments of the disclosure, collision detection is performed on the first three-dimensional spatial structure and the second three-dimensional spatial structure that correspond to a same timestamp, to obtain a collision detection result corresponding to the same timestamp. Therefore, a collision detection feedback result is generated for the first movable device according to the collision detection result corresponding to each of the timestamps of the first movable device within the track time period.

It can be seen that, in some embodiments of the disclosure, the physical size information of the first movable device and a possible interference distance around the first movable device during operation are further introduced during the track planning for the first movable device. In this way, complex real-world factors during operation of the first movable device are fully considered, and a more real first three-dimensional spatial structure can be constructed for the first movable device. Thus, the first movable device is completely enclosed in the set, thereby prompting the detection accuracy when collision detection is performed based on the first three-dimensional spatial structure. In addition, after the first three-dimensional spatial structure is constructed, the first three-dimensional spatial structure of the first movable device and the second three-dimensional spatial structure of the second movable device can be rapidly detected using a relatively simple collision detection policy (e.g., particle and extremum detection) based on three-dimensional spatial structure characteristics of the first three-dimensional spatial structure, thereby improving the detection efficiency of collision detection.

In practical application, an example in which the first movable device is an unmanned aerial vehicle is used. Before allowing the unmanned aerial vehicle to formally operate (for example, execute a flight task), an operator corresponding to the unmanned aerial vehicle needs to declare or apply to a related air traffic management platform for geographical information and flight track information in an airspace in which the unmanned aerial vehicle operates (where the declared content includes, but is not limited to, information such as a time that the unmanned aerial vehicle occupies the airspace, a height, a speed, and a dwell time). In this way, after the operator submits, within a period of time (for example, several minutes or even several seconds) before the unmanned aerial vehicle takes off, the to-be-detected track information obtained from the track planning for the unmanned aerial vehicle to the air traffic management platform, the air traffic management platform needs to quickly analyze the existing track information and the to-be-detected track information submitted by the same operator or multiple operators, to ensure that the unmanned aerial vehicle is not in a limited airspace and has no time and space conflict with other aircraft, so as to ensure that there is no collision risk among a plurality of aircraft, thereby ensuring the safety of a flight task.

Based on this, it can be learned that the air traffic management platform plays a critical role in coordinating flight tasks of a plurality of unmanned aerial vehicles during the operation of the unmanned aerial vehicles. Therefore, the collision detection solution provided in some embodiments of the disclosure may be embedded into the air traffic management platform in a form of an algorithm or the like. The air traffic management platform, alternatively referred to as an air traffic management device, refers to a device used by an air traffic management department having management permission on a given airspace. In this device, air traffic management software may be deployed, and the collision detection solution provided in some embodiments of the disclosure is embedded in the air traffic management software. In this way, the air traffic management platform may be configured to perform collision detection on the to-be-detected track information submitted by an operator to the air traffic management department. Certainly, when the first movable device is another device except the aircraft, the collision detection solution provided in some embodiments of the disclosure may be deployed on a corresponding control platform or device. A specific platform or device on which the collision detection solution is deployed is not limited in some embodiments of the disclosure.

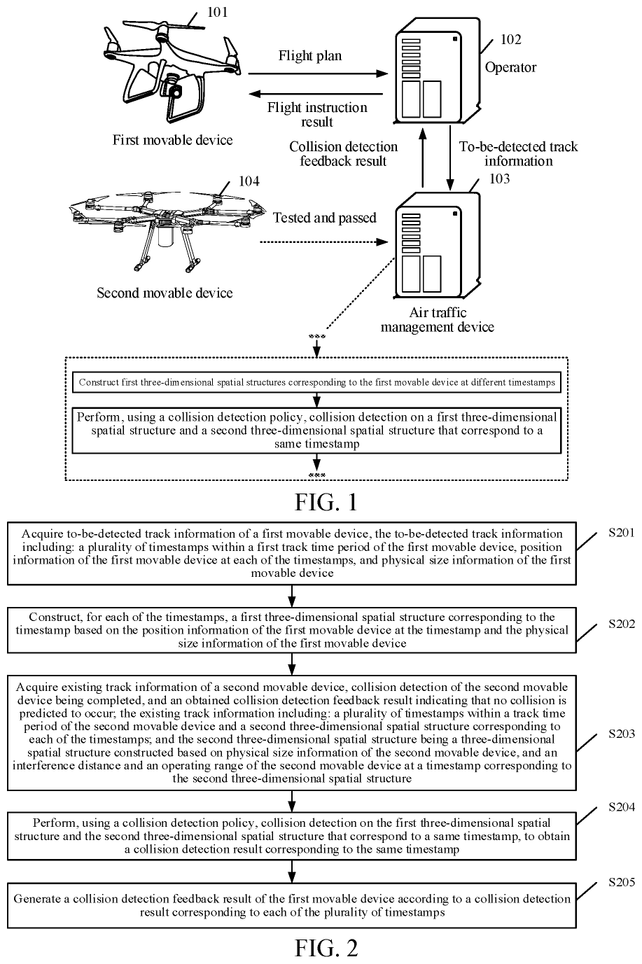

A schematic architectural diagram of a collision detection system using an example in which the movable device is an aircraft may be shown in FIG. 1. The collision detection system, alternatively referred to as an intelligent traffic system (ITS) or intelligent transportation system, is a comprehensive transportation system that effectively and comprehensively applies advanced science and technologies (such as an information technology, a computer technology, a data communication technology, a sensor technology, an electronic control technology, an automatic control theory, operations research, and artificial intelligence) to traffic and transportation, service control, and vehicle manufacture, and enhances associations among aircraft, airspace, and users, to ensure security, improve efficiency, improve an environment, and save energy.

As shown in FIG. 1, the collision detection system includes at least a first movable device 101, an operator device 102 corresponding to the first movable device 101, an air traffic management device 103 corresponding to an air traffic management department, and a second movable device 104 that has been approved by the air traffic management department (e.g., collision detection succeeds, a collision detection result indicates that no collision is predicted to occur in an operation process). 1. In some embodiments of the disclosure, a quantity of first movable devices on which collision detection needs to be performed and a quantity of detected second movable devices are not limited, and a quantity of air traffic management devices and a quantity of operator devices are not limited either. 2. The operator device 102 and the air traffic management device 103 may each be a server. The server may be an independent physical server, may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), a big data and artificial intelligence platform. The foregoing movable device (e.g., the first movable device 101 and the second movable device 104) and the server may be directly or indirectly connected in a wireless communication manner. This is not limited in the disclosure.

In a specific implementation, first, when an object that holds the first movable device 101 has a requirement to operate in the airspace using the first movable device 101, the object may transmit an operation plan or a flight plan to the operator device 102 corresponding to the first movable device 101 through the first movable device 101 (specifically, a remote control device corresponding to the first movable device 101). Then, the operator device 102 performs track planning for the first movable device 101 based on the flight plan of the first movable device 101, and generates to-be-detected track information of the first movable device 101. The operator device 102 transmits the to-be-detected track information of the first movable device 101 to the air traffic management device 103 corresponding to the airspace in which the first movable device 101 intends to operate. Finally, after receiving the to-be-detected track information of the first movable device 101, the air traffic management device 103 may construct, for the first movable device 101, a first three-dimensional spatial structure corresponding to each of a plurality of timestamps within the track time period based on the to-be-detected track information. In addition, the air traffic management device 103 further acquires, from the database, existing track information of the second movable device 104 operating in the same airspace as the first movable device 101, and a second three-dimensional spatial structure corresponding to each of the timestamps within a track time period corresponding to the second movable device in the existing track information. In this way, the air traffic management device 103 may perform, using the collision detection policy designed in some embodiments of the disclosure, collision detection on the first three-dimensional spatial structure and the second three-dimensional spatial structure that correspond to a same timestamp, and generate a collision detection feedback result of the first movable device 101 according to collision detection results corresponding to the timestamps of the first movable device within the entire track time period.

Further, the air traffic management device 103 returns the collision detection feedback result of the first movable device 101 to the operator device 102, so that the operator device 102 may transmit flight indication information to the first movable device 101 based on the collision detection feedback result. For example, when the collision detection feedback result indicates that no collision is predicted to occur when the first movable device 101 operates according to the to-be-detected track information, the flight indication information returned by the operator device 102 may instruct the first movable device 101 to operate according to the track. For another example, when the collision detection feedback result indicates that a collision occurs when the first movable device 101 operates according to the to-be-detected track information, the operator device 102 may generate the flight indication information according to correction prompt information carried in the collision detection feedback result. In this case, the flight indication information includes the correction prompt information to instruct the first movable device 101 to adjust the track. Otherwise, a collision occurs.

Based on the foregoing collision detection solution and system architecture, the following two points further need to be described.

1. The system shown in FIG. 1 mentioned above in some embodiments of the disclosure is intended to describe the technical solutions in some embodiments of the disclosure more clearly, and does not constitute a limitation on the technical solutions provided in some embodiments of the disclosure. A person skilled in the art may learn that, with the evolution of the system architecture and the emergence of a new business scene, the technical solutions provided in some embodiments of the disclosure are also applicable to similar technical problems. For example, an application scene of the collision detection solution is described above using an example in which the movable device is an unmanned aerial vehicle. In practical application, the movable device may alternatively be another device. For example, the first movable device is an unmanned aerial vehicle, and the second movable device is an unmanned vehicle, an unmanned ship, an intelligent robot, or the like. In this scene, the air traffic management device corresponding to the first movable device may need to interact with the control device (for example, a ship control device or a vehicle control device) corresponding to the second movable device to implement collision detection between two fields.

2. The first movable device or the second movable device according to some embodiments of the disclosure includes any one of the foregoing movable devices. For example, the first movable device or the second movable device may include any one of the following: an aircraft, an intelligent robot, a vehicle, or a ship. In some embodiments, the first movable device and the second movable device have a same device type. For example, the first movable device and the second movable device are both aircraft. In some embodiments, the first movable device and the second movable device have different device types. For example, the first movable device is an aircraft, and the second movable device is a ship (for example, a ship that has a large flight deck or a related device capable of accommodating the aircraft). Specific device types of the first movable device and the second movable device are not limited in some embodiments of the disclosure, and are specifically described herein.

3. Collection and processing of relevant data in some embodiments of the disclosure need to strictly comply with the requirements of relevant laws and regulations. Acquisition of personal information needs to be subject to the knowledge or consent of a personal subject (or the legal basis for acquiring the information), and subsequent use and processing of data is carried out within the scope of authorization of laws and regulations and the subject of the personal information. For example, when some embodiments of the disclosure are applied to a specific product or technology, such as acquisition of the to-be-detected track information of the first movable device, permission or consent of an object holding the first movable device needs to be obtained, and collection, use, and processing (such as the collection and publication of live-stream comments issued by the object) of the relevant data need to comply with relevant laws, regulations, and standards of relevant regions.

Based on the foregoing collision detection solution, some embodiments of the disclosure provide a more detailed collision detection method. The collision detection method proposed in some embodiments of the disclosure will be described in detail below with reference to the accompanying drawings.

FIG. 2 is a schematic flowchart of a collision detection method according to some embodiments of the disclosure. The collision detection method may be performed by a computer device (for example, an air traffic management device on which the collision detection method provided in the disclosure is deployed). The collision detection method includes, but is not limited to, operation S201 to operation S205. In the following embodiments, operations may be performed sequentially, in a different order, in parallel, or with some operations skipped or repeated.

S201: Acquire to-be-detected track information of a first movable device.

The first movable device is a movable device having a track detection requirement. For example, the first movable device is an unmanned aerial vehicle having a flight plan. Further, the to-be-detected track information of the first movable device is track information that is generated based on a track plan of the first movable device and on which track detection needs to be performed by a control device (for example, the air traffic management device). The to-be-detected track information of the first movable device includes at least: a plurality of timestamps (e.g., a first plurality of timestamps) within a first track time period of the first movable device, position information of the first movable device at each of the timestamps, and physical size information of the first movable device. 1. The track time period corresponding to the first movable device may be understood as a takeoff and landing time period in which the first movable device plans to fly. For example, when takeoff starts at 9:00 and landing at 10 o'clock, the takeoff time period is a time period from 9:00:00 to 9:10:00. A plurality of timestamps within the track time period may be understood as time points at fixed intervals within this track time period. For example, if the timestamp is 1 second, timestamps within the track time period 9:00-9:10 include at least: 9:00:00, 9:00:01, 9:00:02, . . . , 9:10:00, and the like. 2. The position information of the first movable device at each of the timestamps may refer to coordinates of the first movable device in a space coordinate system at the corresponding timestamp. The position information may be represented in a form of spatial coordinates of the first movable device in the space coordinate system. 3. The physical size information of the first movable device may be configured for reflecting information such as a volume, a shape, and a size of the first movable device. For example, the physical size information of the first movable device is represented as information such as a length, a width, and a height of the first movable device.

In a specific implementation, if an object holding the first movable device wants to fly the first movable device in an airspace, the object may configure the to-be-detected track information of the first movable device in a remote control corresponding to the first movable device, for example, setting a track time period, selecting a timestamp within the track time period, customizing position information corresponding to each of the timestamps, and correcting the physical size information of the first movable device. Then, after the object configuration is completed, the to-be-detected track information of the first movable device is transmitted to the operator device corresponding to the first movable device through the remote control. Then, the operator device may transmit the to-be-detected track information of the first movable device to the air traffic management device. In this case, the air traffic management device determines that the to-be-detected track information of the first movable device is acquired.

The foregoing manner for determining the to-be-detected track information of the first movable device is not fixed. For example, the object may perform only a basic configuration operation in the remote control, for example, setting a track time period, and does not need to select a timestamp. For example, the object sets a flight altitude interval corresponding to the track time period, and does not need to set the position information corresponding to each timestamp. After the remote control transmits the basic information to the operator device, the operator device automatically generates the to-be-detected track information of the first movable device according to the basic information combined with some pre-settings, predictions, and the like. In this way, the object does not need to master complex information configuration rules, but may simply configure information according to intention, thereby effectively reducing the workload of the object. In addition, generating the to-be-detected track information by the operator device may ensure the accuracy of the to-be-detected track information to some extent.

S202: Construct, for each of the timestamps, a first three-dimensional spatial structure corresponding to the timestamp based on the position information of the first movable device at the timestamp and the physical size information of the first movable device.

The first three-dimensional spatial structure corresponding to any timestamp within the track time period of the first movable device is a three-dimensional spatial structure containing an operating range indicated by the position information of the first movable device at the timestamp when an interference distance of the first movable device at the timestamp and the physical size information of the first movable device are considered. The first three-dimensional spatial structure according to some embodiments of the disclosure is a three-dimensional spatial structure constructed based on the physical size of the first movable device, and an interference distance and an operating range of the first movable device at a timestamp corresponding to the first three-dimensional spatial structure. The interference distance of the first movable device at the corresponding timestamp refers to a distance at which interference, such as surrounding airflows or magnetic fields, generated by the first movable device during motion at the timestamp, causes interference or danger to a surrounding adjacent movable device. The interference distance may be determined through a test. Specifically, two movable devices may be operated to fly at different distances, and whether one movable device affects the other movable device is detected using a sensor. The impact is, for example, causing the other movable device to offset or tilt, or generating electromagnetic interference. By introducing the interference distance to each of the timestamps within the track time period of the first movable device, it can be ensured that different movable devices move (for example, fly) at a particular distance, thereby ensuring safe movement among different movable devices. Similarly, the operating range of the first movable device at the corresponding timestamp may refer to a spatial range formed by one or more spatial positions that the first movable device may reach at the timestamp.

Further, a first three-dimensional spatial structure corresponding to the first movable device at the timestamp may refer to FIG. 3. The first three-dimensional spatial structure may be divided into three layers, from the innermost to the outermost, including: a core layer (represented as C1 in FIG. 3), a physical layer (represented as C2 in FIG. 3), and an interference layer (represented as C3 in FIG. 3). The first three-dimensional spatial structure may be considered as the outermost “interference layer”. The interference layer contains the physical layer, and the physical layer contains the core layer. A specific implementation process of constructing a first three-dimensional spatial structure corresponding to a T^{th} timestamp is described below using an example in which any timestamp among the plurality of timestamps within the first track time period is represented as the T^{th} timestamp, T being an integer greater than zero. The specific implementation process may include, but is not limited to, operation s11 to operation s13.

s11: Construct a core layer. The core layer is a three-dimensional spatial structure (for example, a smallest cuboid) that, when the first movable device is used as the particle for track planning, is formed by all spatial positions that the first movable device is capable of reaching at the T^{th} timestamp. The three-dimensional spatial structure includes a set of positions that the first movable device may reach at the T^{th} timestamp.

In practical application, uncertainty in the actual position information of the first movable device at the timestamp may arise due to some reasons (such as weather factors or sudden obstacle avoidance factors) during motion. For example, if the first movable device is an unmanned aerial vehicle, an actual position of the first movable device during flight does not necessarily coincide with a planned position. To accurately determine a possible location of the first movable device at the T^{th} timestamp, some embodiments of the disclosure supports using the concept of the core layer to describe a possible track of the first movable device at the T^{th} timestamp when specific flight path planning is performed on the first movable device, so as to facilitate spatiotemporal dynamic airspace management (e.g., facilitate mastering of the possible position of the first movable device at the T^{th} timestamp).

In a specific implementation, during track planning, the first movable device is supported to be considered as a particle. For example, a point at which a geometric center or a center of gravity of an outer envelope of the first movable device is located is selected as the particle of the first movable device. In this way, the first movable device is used as the particle, and the core layer corresponding to the first movable device at the T^{th} timestamp is constructed according to position information and speed information of the particle at the T^{th} timestamp, and a first time period and a second time period that are adjacent to the T^{th} timestamp for the particle. The speed information of the first movable device at the T^{th} timestamp is carried in the to-be-detected track information of the first movable device. The to-be-detected track information of the first movable device further includes the speed information of the first movable device at each timestamp.

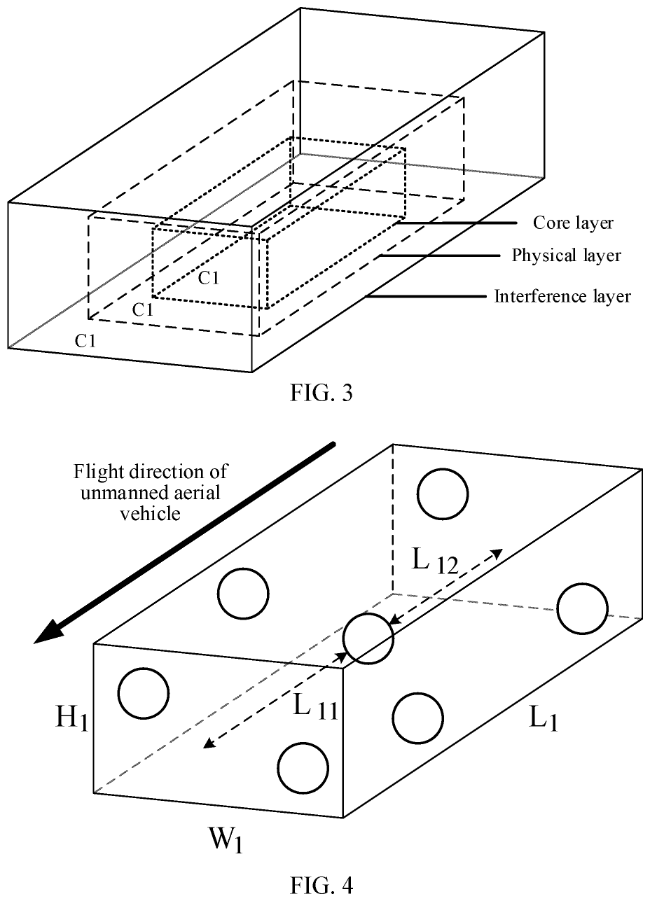

An exemplary schematic diagram of a core layer may refer to FIG. 4. As shown in FIG. 4, it is assumed that a speed of the first movable device at the T^{th} timestamp is V (T), the first time period adjacent to the T^{th} timestamp for the first movable device is T₁, and the second time period is T₂. T₁ is a T₁ time period after the T^{th} timestamp, and T₂ is a T₂ time period before the T^{th} timestamp. Here, the specific duration of the T₁ time period and the specific duration of the T₂ time period are not limited, for example, 0.5 second, which is an error time for the first movable device to reach the position information planned corresponding to the T^{th} timestamp. Then, it is determined that the core layer not only includes the position of the first movable device at the T^{th} timestamp, but also contains positions that the first movable device is likely to appear at T₂ time period before the T^{th} timestamp and the T₁ time period after the T^{th} timestamp.

The core layer contains a set of positions that the first movable device is likely to appear within a time interval [T−T₂, T+T₁]. All spatial positions included in the set of positions are located in the core layer, and the core layer is the three-dimensional spatial structure-a smallest cuboid shown in FIG. 3. The length*width*height of the smallest cuboid=L₁·W₁·H₁.1. The length of the smallest cuboid L₁=L₁₁+L₁₂, where L₁ᵢ=Tᵢ·V(T), and i=1 or 2. When i=1, L₁₁=T₁·V(T) represents a motion distance of the first movable device during the T₁ time period after the T^{th} timestamp. Otherwise, when i=2, L₁₂=T₂·V(T) represents a motion distance of the first movable device during the T₂ time period before the T^{th} timestamp. 2. The width W₁ and the height H₁ of the smallest cuboid may be determined according to a preset condition. The preset condition may include, but is not limited to, at least one of the following: posture information of the first movable device at the T^{th} timestamp, an approximate environmental factor of the position information corresponding to the first movable device at the T^{th} timestamp, a preset fixed value according to experience, or the like. In some embodiments of the disclosure, a specific calculation method of the width W₁ and the height H₁ of the smallest cuboid is not limited, so that the spatial positions that the first movable device, as a particle, may reach at the T^{th} timestamp are contained in the core layer formed by the width and height ranges.

It can be seen that, in some embodiments of the disclosure, when the first three-dimensional spatial structure corresponding to the first movable device at the timestamp is constructed, the error between the actual position and the planned position during the motion of the first movable device is fully considered, and the core layer corresponding to the T^{th} timestamp is constructed for the first movable device, so that the core layer can include a set of all spatial positions that may be reached at the T^{th} timestamp, thereby avoiding a negative impact caused by a position deviation during the motion of the first movable device. For example, the position deviation reduces the accuracy of subsequent collision detection, thereby causing a collision risk for the first movable device.

s12: Construct a physical layer enclosing the core layer. The physical layer is a three-dimensional spatial structure (for example, a smallest cuboid) that, when the first movable device moves to an edge of the core layer, is capable of enclosing an outer contour of the first movable device.

In practical application, if only the spatial positions that the first movable device, as the particle, may reach at the T^{th} timestamp are considered to construct the core layer, when the particle of the first movable device moves to the edge of the core layer, due to the physical size of the first movable device, some physical components of the first movable device are inevitably located outside the core layer. Therefore, determining whether collision or overlap occurs only based on the core layer corresponding to the first movable device at the T^{th} timestamp is insufficient to ensure that all physical parts of the first movable device do not collide. Therefore, some embodiments of the disclosure further supports introducing the physical size information of the first movable device. A physical layer (e.g., the second layer of the first three-dimensional spatial structure) is introduced outside the core layer so that the physical layer completely encloses the core layer. In this way, even if the first movable device is located at the edge of the core layer, a physical outer envelope of the first movable device is still enclosed by the physical layer. If particles of the first movable device exist at all positions in the core layer, the physical layer is a smallest three-dimensional spatial structure that may enclose outer contours of all physical components of the first movable device, and is specifically a smallest cuboid.

In a specific implementation, the air traffic management device supports constructing a physical layer corresponding to the first movable device at the T^{th} timestamp based on the core layer corresponding to the first movable device at the T^{th} timestamp, the posture information of the first movable device at the T^{th} timestamp, and the physical size information of the first movable device. The posture information of the first movable device at the T^{th} timestamp is carried in the to-be-detected track information of the first movable device. For example, the to-be-detected track information of the first movable device includes posture information at each timestamp within the track time period of the first movable device. Further, the posture information of the first movable device at the T^{th} timestamp may be configured for representing a motion posture of the first movable device at the T^{th} timestamp. For example, when the first movable device is an unmanned aerial vehicle, the posture information of the unmanned aerial vehicle may include, but is not limited to, information such as a yaw angle (alternatively referred to as a heading angle), a pitch angle, and a roll angle. The yaw angle of the unmanned aerial vehicle refers to an angle by which a fixed-wing or a rotary-wing aircraft rotates about a longitudinal axis of the unmanned aerial vehicle in vertical flight, or is an included angle between an actual heading and a planned heading of the unmanned aerial vehicle. The pitch angle of the unmanned aerial vehicle refers to an included angle between a body axis (along a head direction) of the unmanned aerial vehicle and a ground plane (horizontal plane) using a head level of the unmanned aerial vehicle as a reference. The roll angle of the unmanned aerial vehicle refers to an angle by which the unmanned aerial vehicle rolls around front and rear axes.

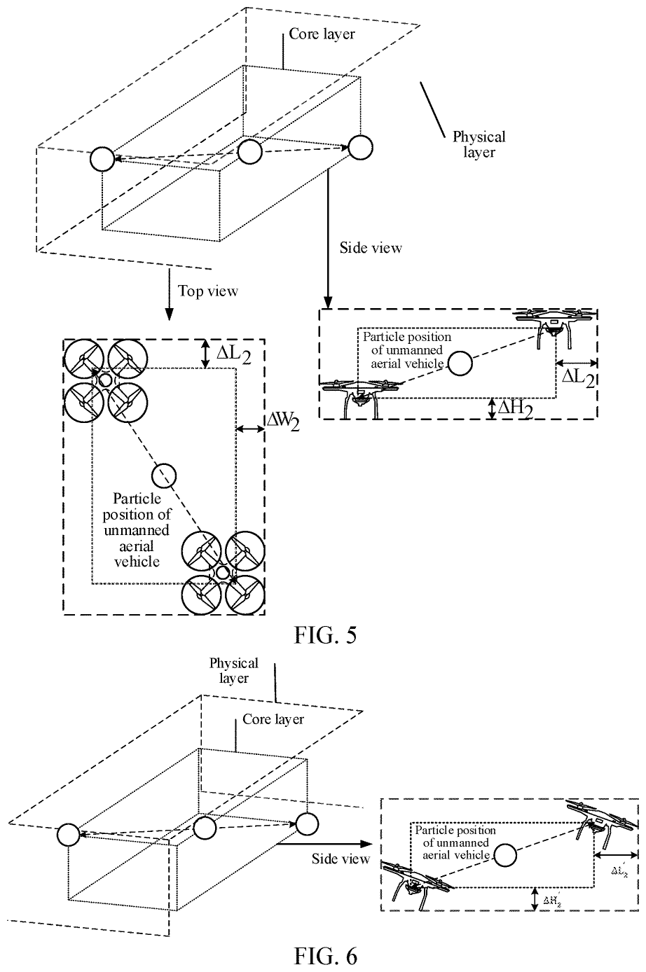

An exemplary schematic diagram of a physical layer may refer to FIG. 5. As shown in FIG. 5, it is assumed that the first movable device is an unmanned aerial vehicle. When the unmanned aerial vehicle moves to the edge of the core layer, some physical components (for example, some wings) of the unmanned aerial vehicle extend beyond the core layer. Therefore, in some embodiments of the disclosure, based on the physical size information of the unmanned aerial vehicle, a physical layer is constructed outside the core layer corresponding to the unmanned aerial vehicle at the T^{th} timestamp. A shape of the physical layer is a cuboid enclosing the entire core layer. An example in which the shape of the unmanned aerial vehicle is centrosymmetric is used. In this case, the smallest size of the physical layer enclosing the core layer is length*width*height=(L₁+2ΔL₂). (W₁+2ΔW²)·(H₁+2ΔH₂). It can be seen from the top view shown in FIG. 5 that when the unmanned aerial vehicle is located at the edge of the core layer, ΔL₂ is a length by which a wing of the unmanned aerial vehicle extends beyond the core layer in a length direction. Similarly, when the unmanned aerial vehicle is located at the edge of the core layer, ΔH₂ is a height by which the wing of the unmanned aerial vehicle extends beyond the core layer in a height direction. Referring to the side view shown in FIG. 4a, when the unmanned aerial vehicle is located at the edge of the core layer, ΔW₂ a width by which the wing of the unmanned aerial vehicle extends beyond the core layer in a width direction.

FIG. 5 is described using an example in which the shape of the unmanned aerial vehicle is centrosymmetric, and the posture information of the unmanned aerial vehicle indicates that both the pitch angle and the roll angle of the unmanned aerial vehicle are zero degrees. However, in practical application, the shape of the unmanned aerial vehicle may not be centrosymmetric, or the posture information of the unmanned aerial vehicle indicates that the unmanned aerial vehicle has a particular pitch angle and/or roll angle and/or heading angle. In this implementation, when the physical layer is constructed for the unmanned aerial vehicle, the physical layer needs to be constructed according to the specific shape and posture information of the unmanned aerial vehicle. An exemplary schematic diagram of constructing a physical layer for an unmanned aerial vehicle when the unmanned aerial vehicle has a particular roll angle may refer to FIG. 6. As shown in FIG. 6, when the unmanned aerial vehicle has a roll angle, when the unmanned aerial vehicle is located at an edge of the core layer, a length by which the unmanned aerial vehicle extends beyond the core layer in a length direction is less than ΔL₂, for example, represented as ΔL′₂. Similarly, when the unmanned aerial vehicle is located at the edge of the core layer, a height by which the unmanned aerial vehicle extends beyond the core layer in a height direction is greater than ΔH₂, for example, represented as ΔH₂. In this case, the smallest size of the physical layer enclosing the core layer is length*width*

$$height = ( {L}_{1} + 2 Δ {L}_{2}^{′} ) \cdot ( {W}_{1} + 2 Δ {W}_{2} ) \cdot ( {H}_{1} + 2 Δ {H}_{2}^{′} ) .$$

It can be seen that some embodiments of the disclosure supports constructing a physical layer with a larger range for the first movable device according to an actual physical size of the first movable device when the first movable device is located at the edge of the core layer, so that the physical layer can completely enclose an outer contour of the first movable device when the first movable device is located at the edge of the core layer, thereby preventing a collision between the outer contour of the first movable device and a surrounding object when the first movable device is located at the edge of the core layer, obviously improving an anti-collision mechanism of the first movable device.

s13: Construct an interference layer enclosing the physical layer (e.g., a first three-dimensional spatial structure corresponding to the first movable device at the T^{th} timestamp). The interference layer is a three-dimensional spatial structure that, when the first movable device moves to the edge of the core layer, is capable of enclosing the interference distance by which the first movable device interferes with the ambient environment.

The core layer and the physical layer that are constructed for the first movable device at the T^{th} timestamp based on the foregoing operations may enclose possible positions of the first movable device at the T^{th} timestamp and corresponding physical components. Further, considering that interference factors that may interfere with other surrounding aircraft or objects exist around the first movable device during flight, there is no collision or overlap between the physical component of the first movable device and the surrounding aircraft or object, but it still cannot be ensured that the track of the first movable device is safe because an airflow, a magnetic field, or the like generated during the motion of the first movable device may also negatively affect the surroundings. Based on this, in some embodiments of the disclosure, it is considered that interference caused by the motion of the first movable device is introduced into an interference layer. For example, a third layer of the first three-dimensional spatial structure. In other examples, if the first movable device existing as a particle exists at all positions in the core layer, the interference layer is a cuboid (or a smallest cuboid) that may enclose an outer contour of all interference distances of the first movable device.

In a specific implementation, after constructing the core layer and the physical layer for the first movable device at the T^{th} timestamp, the air traffic management device may continue to construct the interference layer corresponding to the first movable device at the T^{th} timestamp based on the physical layer and the interference distance of the first movable device to the ambient environment. In this case, the interference layer corresponding to the T^{th} timestamp is the first three-dimensional spatial structure corresponding to the first movable device at the T^{th} timestamp. A specific value of the interference distance of the first movable device to the ambient environment at the T^{th} timestamp is determined according to interference factors of the first movable device at the T^{th} timestamp. For example, the interference factors include airflows, magnetic fields, and wind. This is not limited.

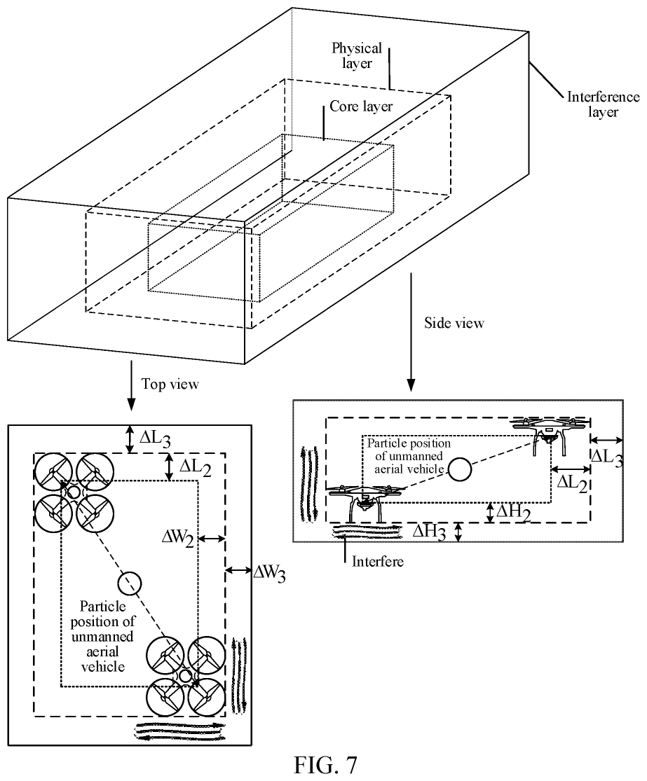

An exemplary schematic diagram of an interference layer may refer to FIG. 7. As shown in FIG. 7, it is assumed that the first movable device is an unmanned aerial vehicle. When the unmanned aerial vehicle is located at the edge of the core layer, the unmanned aerial vehicle may interfere with an ambient environment, for example, generate an airflow (the magnitude of the airflow may be determined according to factors such as a wing rotation rate of the unmanned aerial vehicle). Therefore, in some embodiments of the disclosure, an interference layer is constructed outside the physical layer based on the interference distance generated when the unmanned aerial vehicle is located at the edge of the core layer. A shape of the interference layer is a cuboid (or a smallest cuboid) enclosing the entire physical layer. An example in which a shape of the unmanned aerial vehicle is centrosymmetric, and the interference generated by the unmanned aerial vehicle to the ambient environment is used. In this case, the smallest size of the interference layer enclosing the physical layer is length*width*height=(L₁+2ΔL₂+2ΔL₃). (W₁+2ΔW₂+2ΔW₃). (H₁+2ΔH₂+2ΔH₃), where ΔL₃ is an interference distance of an interference signal generated by the unmanned aerial vehicle to the ambient environment in a length direction when the unmanned aerial vehicle is located at the edge of the core layer. ΔW₃ is an interference distance of an interference signal generated by the unmanned aerial vehicle to the ambient environment in a width direction when the unmanned aerial vehicle is located at the edge of the core layer. ΔH₃ is an interference distance of an interference signal generated by the unmanned aerial vehicle to the ambient environment in a height direction when the unmanned aerial vehicle is located at the edge of the core layer.

In some embodiments of the disclosure, a specific value of the interference distance of the interference signal generated by the first movable device to the ambient environment (for example, in the length direction, the width direction, and the height direction) is not limited. For example, the specific value may be determined according to an empirical value. For another example, the specific value is determined according to the posture information and the speed information that correspond to the first movable device at the T^{th} timestamp. For yet another example, the interference distance of the interference signal generated by the first movable device to the ambient environment is deduced using a model.

It can be seen that, in some embodiments of the disclosure, the interference generated to the ambient environment during the motion of the first movable device is fully considered, and the interference layer is constructed for the first movable device to completely enclose the physical layer. The interference herein may include, but is not limited to, interference or danger caused by surrounding airflows, magnetic fields, or the like to a surrounding adjacent object during the motion of the first movable device. In this way, it is ensured that the first movable device and the surrounding object (such as another movable device) move at a safe distance, thereby greatly improving the operation safety of the first movable device.

In summary, compared with an elliptical cylinder constructed in the conventional technology when only the first movable device is considered as the particle, the first three-dimensional spatial structure constructed for the first movable device based on operation s11 to operation s13 in some embodiments of the disclosure can not only completely enclose the physical components of the first movable device, but also completely enclose the interference distance of the interference signal generated by the first movable device to the ambient environment. Therefore, performing subsequent collision detection based on the first three-dimensional spatial structure may effectively ensure an accurate and reliable collision detection result.

S203: Acquire existing track information of a second movable device, collision detection of the second movable device being completed, and an obtained collision detection feedback result indicating that no collision is predicted to occur; the existing track information including: a plurality of timestamps (e.g., a second plurality of time stamps) within a second track time period of the second movable device and a second three-dimensional spatial structure corresponding to each of the timestamps; and the second three-dimensional spatial structure being a three-dimensional spatial structure constructed based on physical size information of the second movable device, and an interference distance and an operating range of the second movable device at a timestamp corresponding to the second three-dimensional spatial structure.

The interference distance of the second movable device at the corresponding timestamp refers to a distance at which interference, such as surrounding airflows or magnetic fields, generated by the second movable device during motion at the timestamp, causes interference or danger to a surrounding adjacent movable device. The interference distance may be determined through a test. Specifically, two movable devices may be operated to fly at different distances, and whether one movable device affects the other movable device is detected using a sensor. The impact is, for example, causing the other movable device to offset or tilt, or generating electromagnetic interference.

The second movable device refers to a movable device on which collision detection has been performed by the air traffic management device, with the collision detection feedback result indicating that no collision is predicted to occur. Collision detection has been performed on the second movable device and another movable device by the air traffic management device, and the collision detection feedback result indicates that no collision is predicted to occur. To reduce the workload of collision detection of the air traffic management device and improve the collision detection efficiency, some embodiments of the disclosure further supports setting a second movable device whose track airspace is the same as that of a to-be-detected first movable device and whose track time period has an overlapping timestamp. For example, it is assumed that before receiving the to-be-detected track information of the first movable device transmitted by the operator device, the air traffic management device performs collision detection on a second movable device 1 and a second movable device 2, and detection on both of the second movable device 1 and the second movable device 2 succeeds. Therefore, after acquiring the to-be-detected track information of the first movable device, the air traffic management device may compare the timestamp and airspace information (for example, a moving airspace indicating a track corresponding to the first movable device) included in the to-be-detected track information of the first movable device with the second movable device 1 and the second movable device 2. If the air traffic management device detects that the airspace of the track corresponding to the first movable device is the same as or overlaps with the airspace of the track corresponding to the second movable device, and the airspace of the track corresponding to the first movable device is completely different from or does not overlap with the airspace of the track corresponding to the second movable device, the air traffic management device determines the second movable device 1 as the movable device requiring collision detection with the first movable device, and collision detection with the first movable device does not need to be performed on the second movable device 2. The screening mechanism for the second movable device provided in some embodiments of the disclosure can prevent the air traffic management device from detecting all second movable devices that have passed collision detection and the first movable device, thereby reducing the workload of collision detection of the air traffic management device and improving the collision detection efficiency.

The existing track information of the second movable device that is screened for performing collision detection with the first movable device includes at least: a plurality of timestamps within a second track time period of the second movable device and a second three-dimensional spatial structure corresponding to each of the timestamps. The second three-dimensional spatial structure corresponding to the second movable device at each timestamp may be obtained by the air traffic management device through preprocessing. The process of constructing the second three-dimensional spatial structure corresponding to the second movable device at different timestamps by the air traffic management device does not need to be performed until the air traffic management device receives the to-be-detected track information of the first movable device. Instead, construction of the second three-dimensional spatial structures corresponding to all second movable devices at different timestamps may be performed when the air traffic management device is idle. Certainly, the second three-dimensional spatial structure corresponding to the second movable device at the timestamp may alternatively be constructed and pre-stored by the air traffic management device in the process of performing collision detection on the second movable device. When performing collision detection on the first movable device, the air traffic management device directly acquires the pre-stored second three-dimensional spatial structure corresponding to the second movable device at different timestamps. A construction moment of the second three-dimensional spatial structure of the second movable device at different timestamps is not limited in some embodiments of the disclosure, and a construction manner of the second three-dimensional spatial structure is similar to that of the first three-dimensional spatial structure corresponding to the first movable device at the timestamp described above. Details are not described herein again.

Further, there may be one or more second movable devices configured to perform collision detection with the first movable device. When there are a plurality of second movable devices, a specific implementation process of performing collision detection between each of the second movable devices and the first movable device is the same. Subsequently, the collision detection process between the second movable device and the first movable device is described in detail using only a single second movable device as an example.

S204: Perform, using a collision detection policy, collision detection on the first three-dimensional spatial structure and the second three-dimensional spatial structure that correspond to a same timestamp, to obtain a collision detection result corresponding to the same timestamp.

Performing collision detection on the first three-dimensional spatial structure and the second three-dimensional spatial structure that correspond to the same timestamp may be to determine whether the first three-dimensional spatial structure and the second three-dimensional spatial structure that correspond to the same timestamp overlap. If the first three-dimensional spatial structure and the second three-dimensional spatial structure that correspond to the same timestamp overlap, a collision is predicted to occur at this timestamp; if they do not overlap, no collision is predicted to occur at this timestamp.

S205: Generate a collision detection feedback result of the first movable device according to a collision detection result corresponding to each of the plurality of timestamps.

In operation S204 to operation S205, it is considered that a condition under which the first movable device and the second movable device collide is that the first movable device and the second movable device are located at the same or a close position at the same timestamp. Based on this, after constructing the corresponding first three-dimensional spatial structure for the first movable device at each of the plurality of timestamps and acquiring the second three-dimensional spatial structure corresponding to the second movable device at each of the plurality of timestamps based on the foregoing operations, the air traffic management device may perform, using the collision detection policy designed in some embodiments of the disclosure, collision detection on the first three-dimensional spatial structure and the second three-dimensional spatial structure that correspond to the same timestamp, to obtain the collision detection result corresponding to the same timestamp. Further, the air traffic management device may generate the collision detection feedback result of the first movable device based on the collision detection result corresponding to each of the plurality of timestamps included in the track corresponding to the first movable device. If the collision detection result corresponding to each of the plurality of timestamps within the track time period of the first movable device indicates that no collision is predicted to occur, the collision detection feedback result indicates that no collision is predicted to occur when the first movable device moves according to the track planning. Otherwise, if a collision detection result corresponding to at least one of the plurality of timestamps indicates that a collision is predicted to occur, the collision detection feedback result indicates that the first movable device will collide.

In summary, in some embodiments of the disclosure, a construction logic of a three-layer three-dimensional spatial structure is creatively provided with reference to the physical size of the first movable device and the interference to the ambient environment. A corresponding first three-dimensional spatial structure is constructed for the first movable device at each timestamp, to ensure that the three-dimensional spatial structure subsequently used for collision detection can not only completely enclose the physical components of the entire first movable device, but also enclose an interference range of the interference signal generated by the first movable device to the ambient environment during operation, thereby greatly improving the safety of the first movable device during operation.

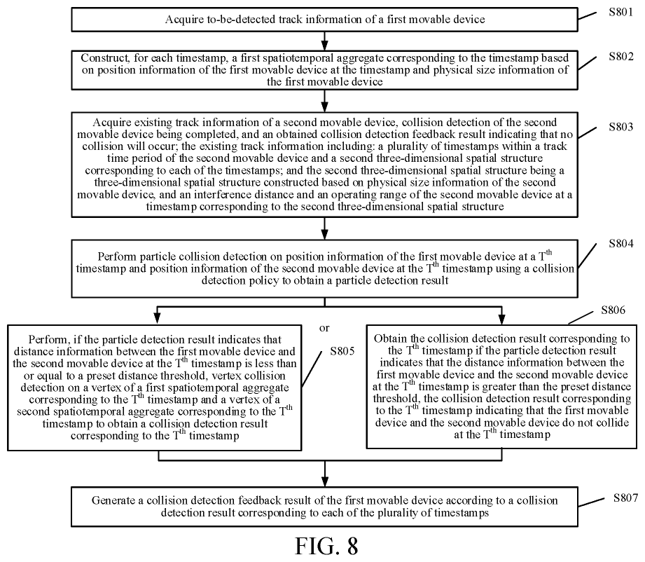

FIG. 8 is a schematic flowchart of another collision detection method according to some embodiments of the disclosure. In the following embodiments, operations may be performed sequentially, in a different order, in parallel, or with some operations skipped or repeated. The collision detection method may be performed by a computer device (for example, an air traffic management device on which the collision detection method provided in the disclosure is deployed). The collision detection method includes, but is not limited to, operation S801 to operation S807.

S801: Acquire to-be-detected track information of a first movable device.

S802: Construct, for each timestamp, a first three-dimensional spatial structure corresponding to the timestamp based on position information of the first movable device at the timestamp and physical size information of the first movable device.

S803: Acquire existing track information of a second movable device, collision detection of the second movable device being completed, and an obtained collision detection feedback result indicating that no collision is predicted to occur; the existing track information including: a plurality of timestamps within a second track time period of the second movable device and a second three-dimensional spatial structure corresponding to each of the timestamps; and the second three-dimensional spatial structure being a three-dimensional spatial structure constructed based on physical size information of the second movable device, and an interference distance and an operating range of the second movable device at a timestamp corresponding to the second three-dimensional spatial structure.

A specific implementation process shown in operation S801 to operation S803 may refer to related descriptions of the specific implementation process shown in operation S201 to operation S202 in some embodiments shown in FIG. 2. Details are not described herein again.

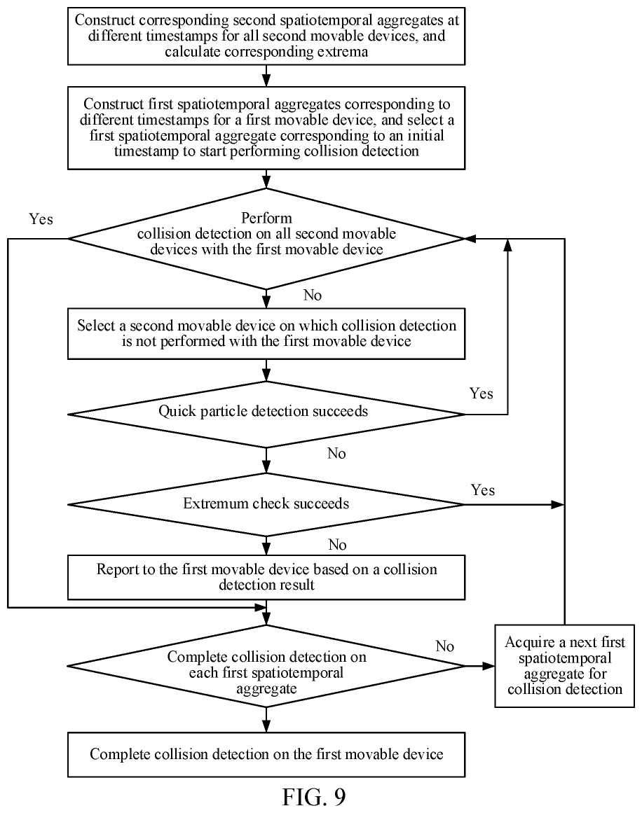

In addition, when there are one or more second movable devices, specific implementation logic of collision detection between the first movable device and the one or more second movable devices may refer to FIG. 9. In the following embodiments, operations may be performed sequentially, in a different order, in parallel, or with some operations skipped or repeated. As shown in FIG. 9,

First, the air traffic management device constructs a second three-dimensional spatial structure for each of the one or more second movable devices at a corresponding timestamp, and determines an extremum vertex for each second spatiotemporal aggregate. Similarly, the air traffic management device further constructs a first three-dimensional spatial structure corresponding to each timestamp for the to-be-detected first movable device, and determines a corresponding extremum vertex for each first three-dimensional spatial structure. The extremum vertex may be understood as a maximum vertex and a minimum vertex in 8 vertexes of a cuboid when the three-dimensional spatial structure (for example, the first three-dimensional spatial structure or the second three-dimensional spatial structure) is the cuboid. The extremum vertex will be further described subsequently.

Then, according to an order of the timestamps, a first three-dimensional spatial structure corresponding to an initial timestamp (e.g., a timestamp indicating the earliest time point) is determined from the plurality of timestamps corresponding to the first movable device, and whether collision detection is performed on the second three-dimensional spatial structure corresponding to each of the one or more second movable devices at the initial timestamp with the first three-dimensional spatial structure corresponding to the first movable device at the initial timestamp. If collision detection is performed on the second three-dimensional spatial structure corresponding to each of the second movable devices at the initial timestamp with the first three-dimensional spatial structure corresponding to the first movable device at the initial timestamp, the first movable device does not collide with any second movable device that has applied for flight at the initial timestamp. Then, whether the first movable device further has a first spatiotemporal aggregate corresponding to a to-be-detected timestamp is detected, and if yes, the collision detection continues to be performed on a first three-dimensional spatial structure corresponding to the to-be-detected timestamp. Otherwise, if collision detection is not performed on a second three-dimensional spatial structure corresponding to at least one second movable device of the one or more second movable devices at the corresponding initial timestamp with the first three-dimensional spatial structure corresponding to the first movable device at the initial timestamp, a second movable device that is not detected is selected from the at least one second movable device, and particle detection is performed on the second three-dimensional spatial structure corresponding to the second movable device at the initial timestamp and the first three-dimensional spatial structure corresponding to the first movable device at the initial timestamp.

Secondly, if a particle detection result obtained by performing particle detection on the second three-dimensional spatial structure corresponding to the second movable device at the initial timestamp and the first three-dimensional spatial structure corresponding to the first movable device at the initial timestamp indicates that the particle detection succeeds, when the second movable device moves to the second three-dimensional spatial structure corresponding to the initial timestamp, and the first movable device moves to the first three-dimensional spatial structure corresponding to the initial timestamp, no collision is predicted to occur. Then, a to-be-detected second movable device continues to be selected from the at least one second movable device to perform the foregoing particle detection. Otherwise, if the particle detection result obtained by performing particle detection on the second three-dimensional spatial structure corresponding to the second movable device at the initial timestamp and the first three-dimensional spatial structure corresponding to the first movable device at the initial timestamp indicates that the particle detection fails, when the second movable device moves to the second three-dimensional spatial structure corresponding to the initial timestamp, and the first movable device moves to the first three-dimensional spatial structure corresponding to the initial timestamp, a collision may occur. Then, vertex collision detection (alternatively referred to as extremum detection) continues to be performed on the second three-dimensional spatial structure corresponding to the second movable device at the initial timestamp and the first three-dimensional spatial structure corresponding to the first movable device at the initial timestamp, to obtain a collision detection result corresponding to the initial timestamp.

Finally, if the collision detection result corresponding to the initial timestamp indicates that a collision may occur when the second movable device moves to the second three-dimensional spatial structure corresponding to the initial timestamp and the first movable device moves to the first three-dimensional spatial structure corresponding to the initial timestamp, the air traffic management device may record related information of the initial timestamp at which the collision occurs, and reports the information to the object holding the first movable device. In addition, the air traffic management device may further continue to detect whether a first three-dimensional spatial structure corresponding to a next timestamp corresponding to the initial timestamp collides. Otherwise, if the collision detection result corresponding to the initial timestamp indicates that no collision is predicted to occur when the second movable device moves to the second three-dimensional spatial structure corresponding to the initial timestamp and the first movable device moves to the first three-dimensional spatial structure corresponding to the initial timestamp, the air traffic management device may further continue to detect whether the first three-dimensional spatial structure corresponding to the next timestamp corresponding to the initial timestamp collides, until collision detection is performed between the first three-dimensional spatial structure corresponding to each timestamp within the track time period in the first spatiotemporal aggregate and the second three-dimensional spatial structure corresponding to each of the at least one second movable device at the corresponding timestamp.

1. FIG. 9 shows an approximate procedure of implementing collision detection according to an order of the timestamps. In practical application, it is considered that the first movable device and the second movable device may collide only when they are located at the same or a close position at the same timestamp. Therefore, in some embodiments of the disclosure, before collision detection between the first movable device and the second movable device for a timestamp is implemented using the particle and the extremum, it is further supported to first determine timestamps at which collision detection needs to be performed on the first movable device and the second movable device. (e.g., which timestamps indicate the same time points). However, collision detection does not need to be performed at different timestamps. Thus, the overhead caused by performing collision detection on all timestamps may be avoided to some extent, and the efficiency of collision detection can be improved.

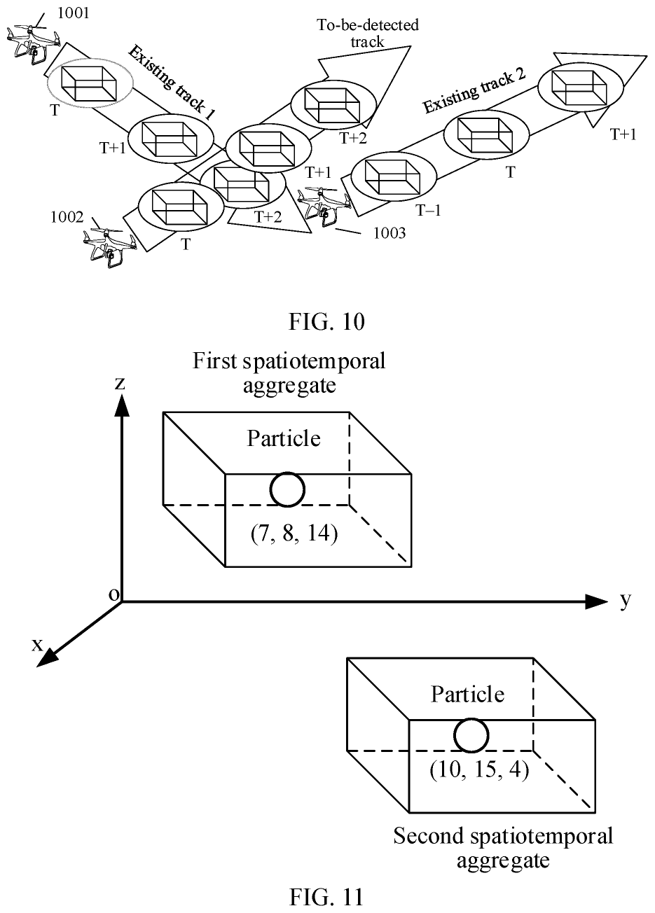

For example, as shown in FIG. 10, it is assumed that the air traffic management device has performed collision detection on a second movable device 1001 and a second movable device 1002, and a detection result indicates that the second movable device 1001 and the second movable device 1002 do not collide with surrounding objects during motion. A track time period of the second movable device 1001 includes a timestamp T, a timestamp T+1, and a timestamp T+2, and a track time period of the second movable device 1002 includes a timestamp T−1, a timestamp T, and a timestamp T+1. In addition, a track time period of a to-be-detected first movable device 1003 acquired by the air traffic management device includes a timestamp T, a timestamp T+1, and a timestamp T+2. Therefore, if it is determined that only the second movable device 1002 has a flight plan at the timestamp T−1, collision detection between the first movable device 1003 and the second movable device 1002 does not need to be performed at the timestamp T−1. Similarly, when the second movable device 1001, the second movable device 1002, and the first movable device 1003 each have a flight plan at the timestamp T, collision detection between the first movable device 1003 and the second movable device 1001 and collision detection between the first movable device 1003 and the second movable device 1002 need to be performed at the timestamp T. Similarly, when the second movable device 1001, the second movable device 1002, and the first movable device 1003 each have a flight plan at the timestamp T+1, collision detection between the first movable device 1003 and the second movable device 1001 and collision detection between the first movable device 1003 and the second movable device 1002 need to be performed at the timestamp T+1. Similarly, when only the second movable device 1001 and the first movable device 1003 have a flight plan at the timestamp T+2, collision detection between the first movable device 1003 and the second movable device 1001 needs to be performed at the timestamp T+2.

2. In FIG. 9 and FIG. 10, the collision detection procedure between the first movable device and one or more second movable devices are described from an overall perspective. A specific implementation process of performing, using the collision detection policy, collision detection on a first three-dimensional spatial structure corresponding to the first movable device at any timestamp (for example, a T^{th} timestamp) and a second three-dimensional spatial structure corresponding to the second movable device at the timestamp may refer to the following operation S804 to operation S806.

S804: Perform particle collision detection on the position information of the first movable device at the T^{th} timestamp and position information of the second movable device at the T^{th} timestamp using the collision detection policy to obtain a particle detection result.

The position information of the first movable device at the T^{th} timestamp may be a position of the first movable device at the T^{th} timestamp when the first movable device is considered as a particle, and is specifically a central position of the first movable device in the first three-dimensional spatial structure corresponding to the T^{th} timestamp. The position information is represented in a form of spatial coordinates. The spatial position is calculated based on a three-dimensional spatial coordinate system, and the spatial coordinate system includes a first coordinate value X, a second coordinate value Y, and a third coordinate value Z. Then, after the position information of the first movable device at the T^{th} timestamp and the position information of the second movable device at the T^{th} timestamp are acquired, the position information of the first movable device and the position information of the second movable device at the T^{th} timestamp may be directly detected. If a distance between the two particles is relatively large, two three-dimensional spatial structures (e.g., the first three-dimensional spatial structure and the second three-dimensional spatial structure) corresponding to the two particles certainly have no overlapping area at the T^{th} timestamp, and it is determined that the first movable device and the second movable device are predicted not to collide at the T^{th} timestamp. If the distance between the two particles is relatively small, the two three-dimensional spatial structures (e.g., the first three-dimensional spatial structure and the second three-dimensional spatial structure) corresponding to the two particles may have an overlapping area at the T^{th} timestamp, and it is determined that the first movable device and the second movable device may collide at the T^{th} timestamp. Then, subsequent extremum detection needs to be performed.

A specific implementation process of the particle collision detection may include: comparing a first coordinate value of the first movable device at the T^{th} timestamp with a first coordinate value of the second movable device at the T^{th} timestamp using the collision detection policy to obtain a first comparison subresult corresponding to the first coordinate value. The first comparison subresult indicates distance information between the first movable device and the second movable device at the T^{th} timestamp in an X direction. Similarly, a second coordinate value of the first movable device at the T^{th} timestamp is compared with a second coordinate value of the second movable device at the T^{th} timestamp using the collision detection policy to obtain a second comparison subresult corresponding to the second coordinate value. The second comparison subresult indicates distance information between the first movable device and the second movable device at the T^{th} timestamp in a Y direction. Similarly, a third coordinate value of the first movable device at the T^{th} timestamp is compared with a third coordinate value of the second movable device at the T^{th} timestamp using the collision detection policy to obtain a third comparison subresult corresponding to the third coordinate value. The third comparison subresult indicates distance information between the first movable device and the second movable device at the T^{th} timestamp in a z direction. In this way, the particle detection result may be generated based on the first comparison subresult, the second comparison subresult, and the third comparison subresult. When the particle detection result indicates that the distance information between the first movable device and the second movable device at the T^{th} timestamp is less than or equal to a preset distance threshold, the first movable device and the second movable device may collide at the T^{th} timestamp, and operation S805 is triggered to be performed. Alternatively, when the particle detection result indicates that the distance information between the first movable device and the second movable device at the T^{th} timestamp is greater than the preset distance threshold, the first movable device and the second movable device are predicted not to collide at the T^{th} timestamp, and operation S806 is triggered to be performed.

Further, considering that the first three-dimensional spatial structure corresponding to the first movable device at the T^{th} timestamp may be a cuboid, a central point of the cuboid (e.g., the position of the first movable device as the particle) and a position of the second movable device at the T^{th} timestamp may have different preset distance thresholds for collision avoidance in the X, Y, and Z directions. Each coordinate value in the spatial position corresponds to one preset distance threshold. For example, each coordinate direction corresponds to one preset distance threshold. Based on this, in some embodiments of the disclosure, after the comparison subresults (e.g., the first comparison subresult, the second comparison subresult, and the third comparison subresult, in the X, Y, and Z directions) are obtained based on the foregoing operations, the logic of generating, by the air traffic management device, the particle detection result based on the first comparison subresult, the second comparison subresult, and the third comparison subresult may include: generating the particle detection result if any one of following cases is satisfied: the first comparison subresult is less than a preset distance threshold corresponding to the first coordinate value, the second comparison subresult is less than a preset distance threshold corresponding to the second coordinate value, or the third comparison subresult is less than a preset distance threshold corresponding to the third coordinate value, in this case, the particle detection result indicating that the first movable device and the second movable device collide at the T^{th} timestamp; or generating the particle detection result if the first comparison subresult is greater than or equal to the preset distance threshold corresponding to the first coordinate value, the second comparison subresult is greater than or equal to the preset distance threshold corresponding to the second coordinate value, and the third comparison subresult is greater than or equal to the preset distance threshold corresponding to the third coordinate value, in this case, the particle detection result indicating that the first movable device and the second movable device are predicted not to collide at the T^{th} timestamp.

Specific values of the preset distance thresholds in the X, Y, and Z directions are related to the length, the width, and the height of the three-dimensional spatial structures respectively corresponding to the first movable device and the second movable device at the T^{th} timestamp. For example, the Y direction is the length of the three-dimensional spatial structure, the length of the first three-dimensional spatial structure corresponding to the first movable device at the T^{th} timestamp is 3, and the length of the second three-dimensional spatial structure corresponding to the second movable device at the T^{th} timestamp is 5. Therefore, considering that the particle is located at the central point of the three-dimensional spatial structure, it is determined that a preset distance threshold between the particle in the first three-dimensional spatial structure and the particle in the second three-dimensional spatial structure in the Y direction is 3/2+5/2=4. For another example, the Z direction is the height of the three-dimensional spatial structure, the height of the first three-dimensional spatial structure corresponding to the first movable device at the T^{th} timestamp is 8, and the height of the second three-dimensional spatial structure corresponding to the second movable device at the T^{th} timestamp is 6. Therefore, considering that the particle is located at the central point of the three-dimensional spatial structure, it is determined that the preset distance threshold between the particle in the first three-dimensional spatial structure and the particle in the second three-dimensional spatial structure in the Z direction is 8/2+6/2=7.

For example, as shown in FIG. 11, it is assumed that a spatial position of the first movable device, as a particle, at the T^{th} timestamp is (7, 8, 14), and a spatial position of the second movable device, as a particle, at the T^{th} timestamp is (10, 15, 4). A preset distance threshold between the first movable device and the second movable device in the X direction at the T^{th} timestamp is 2, in the Y direction is 8, and in the Z direction is 2. Then, it is determined that distance information (e.g., the first comparison subresult, alternatively referred to as a difference) in the X direction is 3, and is greater than the preset distance threshold 2 in the X direction. Similarly, it is determined that distance information (e.g., the second comparison subresult) in the Y direction is 7, and is less than the preset distance threshold 8 in the Y direction. Similarly, it is determined that distance information (e.g., the third comparison subresult) in the Z direction is 10, and is greater than the preset distance threshold 2 in the Z direction. Since the distance information 7 between the first movable device and the second movable device in the Y direction at the T^{th} timestamp is less than the preset distance threshold 8, it is determined that there is an overlapping area between the first three-dimensional spatial structure corresponding to the first movable device at the T^{th} timestamp and the second three-dimensional spatial structure corresponding to the second movable device at the T^{th} timestamp, and it is further determined that the first movable device and the second movable device collide at the T^{th} timestamp. Then, the collision detection result corresponding to the T^{th} timestamp indicates that the first movable device and the second movable device may collide at the T^{th} timestamp.

S805: Perform, if the particle detection result indicates that distance information between the first movable device and the second movable device at the T^{th} timestamp is less than or equal to a preset distance threshold, vertex collision detection on a vertex of the first three-dimensional spatial structure corresponding to the T^{th} timestamp and a vertex of a second three-dimensional spatial structure corresponding to the T^{th} timestamp to obtain a collision detection result corresponding to the T^{th} timestamp.

Based on the particle detection process shown in operation S804, if the particle detection result obtained by performing particle detection on the position of the first movable device at the T^{th} timestamp and the position of the second movable device at the T^{th} timestamp indicates that: the distance information between the first movable device and the second movable device at the T^{th} timestamp is less than or equal to a preset distance threshold, for example, the distance information (e.g., the foregoing comparison subresult) in at least one of the X, Y, and Z directions is less than or equal to a corresponding preset distance threshold, there may be an overlapping area between the first three-dimensional spatial structure corresponding to the first movable device at the T^{th} timestamp and the second three-dimensional spatial structure corresponding to the second movable device at the T^{th} timestamp. For example, the first movable device and the second movable device are likely to collide at the T^{th} timestamp. Therefore, in some embodiments of the disclosure, an extremum detection policy (alternatively referred to as a vertex collision detection policy) is further designed to further detect a collision situation of the first movable device and the second movable device at the T^{th} timestamp.

In a specific implementation, if the air traffic management device determines that the particle detection result of the first movable device and the second movable device at the T^{th} timestamp indicates that the first movable device and the second movable device may collide, the air traffic management device may calculate an extremum of a capsule (the capsule herein may be immediately the first three-dimensional spatial structure) for the first three-dimensional spatial structure corresponding to the first movable device at the T^{th} timestamp, to obtain an extremum vertex of the first three-dimensional spatial structure and vertex coordinates of the extremum vertex. In addition, vertex coordinates of an extremum vertex in the second three-dimensional spatial structure corresponding to the second movable device at the T^{th} timestamp are acquired.

1. An extremum vertex of a three-dimensional spatial structure (for example, the first three-dimensional spatial structure or the second three-dimensional spatial structure) may refer to a point whose spatial coordinates in the three-dimensional spatial structure take an extremum (for example, taking a maximum value or a minimum value). The extremum herein may refer to an X value, a Y value, and a Z value of the spatial coordinates being minimum coordinates in the three-dimensional spatial structure. When the three-dimensional spatial structure is a cuboid, points whose spatial coordinates take extrema belong to 8 vertexes of the cuboid. In this case, the extremum vertex of the three-dimensional spatial structure refers to a vertex whose spatial coordinates take an extremum among a plurality of vertexes included in the three-dimensional spatial structure. Therefore, in some embodiments of the disclosure, a point whose spatial coordinates take an extremum may be referred to as an extremum vertex. 2. A specific process of calculating the extremum of the capsule for the three-dimensional spatial structure is not limited in some embodiments of the disclosure. For example, the process of calculating the extremum of the capsule for the first three-dimensional spatial structure may include, but is not limited to: calculating vertex coordinates of an extremum vertex in the first three-dimensional spatial structure corresponding to the T^{th} timestamp according to the position information of the first movable device at the T^{th} timestamp, the physical size information of the first movable device, and the posture information of the first movable device at the T^{th} timestamp (the to-be-detected track information of the first movable device includes the posture information of the first movable device at the T^{th} timestamp). In more detail, when coordinates of the particle in the first three-dimensional spatial structure are clearly known according to the position information of the first movable device at the T^{th} timestamp, information such as the length, the width, and the height of the first three-dimensional spatial structure may be known according to the first three-dimensional spatial structure corresponding to the T^{th} timestamp constructed for the first movable device, and the to-be-detected track information of the first movable device already includes the posture information of the first movable device at the T^{th} timestamp, X values, Y values, and Z values of all points in the first three-dimensional spatial structure are placed into three sets, respectively. In this way, spatial coordinates formed by maximum values selected from the three sets are vertex coordinates of an extremum vertex taking a maximum value in the first three-dimensional spatial structure. Similarly, spatial coordinates formed by minimum values selected from the three sets are vertex coordinates of an extremum vertex taking a minimum value in the first three-dimensional spatial structure, thereby obtaining the extremum vertex of the first three-dimensional spatial structure and the vertex coordinates of the extremum vertex.

Based on the foregoing description, after obtaining the vertex coordinates of the extremum vertex of the first three-dimensional spatial structure corresponding to the first movable device at the T^{th} timestamp and the vertex coordinates of the extremum vertex of the second three-dimensional spatial structure corresponding to the second movable device at the T^{th} timestamp, the air traffic management device may calculate the vertex coordinates of the extremum vertex in the first three-dimensional spatial structure corresponding to the first movable device at the T^{th} timestamp and the vertex coordinates of the extremum vertex in the second three-dimensional spatial structure corresponding to the second movable device at the T^{th} timestamp using an extremum check rule to obtain the collision detection result corresponding to the T^{th} timestamp. The collision detection result corresponding to the T^{th} timestamp is configured for indicating that: the first movable device and the second movable device collide at the T^{th} timestamp, or do not collide at the T^{th} timestamp.

The extremum check rule may be represented as the following determining condition:

$$( {X}_{0 min} < {X}_{imax} ) AND ( {X}_{imin} < {X}_{0 max} ) AND ( \text{} {Y}_{0 min} < {Y}_{imax} ) \text{} AND ( \text{} {Y}_{imin} < {Y}_{0 max} ) \text{} AND ( \text{} {Z}_{0 min} < {Z}_{imax} ) \text{} AND ( \text{} {Z}_{imin} < {Z}_{0 max} ) ,$$

where 0 is the first movable device, i is an i^{th} second movable device, values of i are 1, 2, . . . , and n, and n is a positive integer. X₀ₘᵢₙ, Y₀ₘᵢₙ, and Z₀ₘᵢₙ are vertex coordinates of a smallest extremum vertex in the first three-dimensional spatial structure corresponding to the first movable device at the T^{th} timestamp, X₀ₘₐₓ, Y₀ₘₐₓ, and Z₀ₘₐₓ are vertex coordinates of a maximum extremum vertex in the first three-dimensional spatial structure corresponding to the first movable device at the T^{th} timestamp. Xᵢₘᵢₙ, Yᵢₘᵢₙ, and Zᵢₘᵢₙ are vertex coordinates of a smallest extremum vertex in a second three-dimensional spatial structure corresponding to the i^{th} second movable device at the T^{th} timestamp. Xᵢₘₐₓ, Yᵢₘₐₓ, and Zᵢₘₐₓ are vertex coordinates of a maximum extremum vertex in the second three-dimensional spatial structure corresponding to the i^{th} second movable device at the T^{th} timestamp.

It can be learned from the foregoing extremum check rule that the extremum check rule includes a plurality of determining formulas, and specifically includes 6 determining formulas. For example, a determining formula is: (X₀ₘᵢₙ<Xᵢₘₐₓ). Therefore, when each of the plurality of determining formulas is true (e.g., when a comparison relationship represented by each determining formula is valid), there is an overlapping area (or an overlapping phenomenon) between the first three-dimensional spatial structure corresponding to the first movable device at the T^{th} timestamp and the second three-dimensional spatial structure corresponding to the i^{th} second movable device at the T^{th} timestamp, and it is determined that the collision detection result corresponding to the T^{th} timestamp indicates that the first movable device and the i^{th} second movable device collide at the T^{th} timestamp. Otherwise, when at least one of the plurality of determining formulas is false, there is no overlapping area between the first three-dimensional spatial structure corresponding to the first movable device at the T^{th} timestamp and the second three-dimensional spatial structure corresponding to the i^{th} second movable device at the T^{th} timestamp, and then it is determined that the collision detection result corresponding to the T^{th} timestamp indicates that the first movable device and the i^{th} second movable device are predicted not to collide at T^{th} timestamp. Determining formula being true may refer to the determining formula being satisfied. Also, determining formula being false may refer to the determining formula being unsatisfied.

1. In the process of performing vertex collision detection on the first movable device and the i^{th} second movable device at the T^{th} timestamp using the foregoing extremum check rule, if it is detected that a collision occurs, a process of determining a collision between the first movable device and the i^{th} second movable device may be terminated. In this case, a determination result of the first movable device and the i^{th} second movable device at the T^{th} timestamp indicates that the first movable device and the i^{th} second movable device may collide. Alternatively, determination of a subsequent timestamp may be selected to continue. In this way, all collision points (for example, target timestamps at which a collision may occur) at which the first movable device and the i^{th} second movable device may collide may be marked from a plurality of timestamps, and the result is returned to the object holding the first movable device. 2. For the first movable device, only when it is determined that the first movable device does not collide with each of the n second movable devices, it may be determined that the first movable device is predicted not to collide during motion according to a planned track. If the first movable device collides with any one of the n second movable devices, it is determined that the first movable device will collide during motion according to the planned track.

S806: Obtain the collision detection result corresponding to the T^{th} timestamp if the particle detection result indicates that the distance information between the first movable device and the second movable device at the T^{th} timestamp is greater than the preset distance threshold, the collision detection result corresponding to the T^{th} timestamp indicating that the first movable device and the second movable device are predicted not to collide at the T^{th} timestamp.

Based on the particle detection process shown in operation S804, if the particle detection result obtained by performing particle detection on the position of the first movable device at the T^{th} timestamp and the position of the second movable device at the T^{th} timestamp indicates that: the distance information between the first movable device and the second movable device at the T^{th} timestamp is greater than a preset distance threshold, for example, the distance information (e.g., the foregoing comparison subresults) in X, Y, and Z directions is greater than a corresponding preset distance threshold, there is no overlapping area between the first three-dimensional spatial structure corresponding to the first movable device at the T^{th} timestamp and the second three-dimensional spatial structure corresponding to the second movable device at the T^{th} timestamp. For example, the first movable device and the second movable device are predicted not to collide at the T^{th} timestamp. Therefore, vertex collision detection shown in operation S805 does not need to be performed, but the collision detection result corresponding to the first movable device at the T^{th} timestamp is directly generated. In this case, the collision detection result corresponding to the T^{th} timestamp indicates that the first movable device and the second movable device are predicted not to collide at the T^{th} timestamp.

In summary, it can be learned from the foregoing collision detection policy shown in operation S804 to operation S806 that the particles in the first three-dimensional spatial structure and the second three-dimensional spatial structure are easily obtained, for example, the particle in the first three-dimensional spatial structure is the position information of the first movable device at the corresponding timestamp, and a calculation amount of differences between the particles in the X, Y, and Z directions is also very small. Therefore, in some embodiments of the disclosure, such a particle detection manner is set to implement the collision detection of the first movable device, so that a calculation amount of the collision detection may be reduced while ensuring the accuracy of the collision detection. In addition, in some embodiments of the disclosure, subsequent vertex collision detection is triggered to be performed only when the particle detection result indicates that the first movable device and the second movable device may collide, thereby reducing the calculation overhead required for the collision detection, and greatly improving the detection efficiency of the collision detection by introducing the vertex collision detection.

S807: Generate a collision detection feedback result of the first movable device according to a collision detection result corresponding to each of the plurality of timestamps.

As described above, the track time period of the first movable device includes a plurality of timestamps. Therefore, only when the collision detection result corresponding to each of the plurality of timestamps indicates that the first movable device and the second movable device are predicted not to collide at the corresponding timestamp, the generated collision detection feedback result of the first movable device indicates that the first movable device is predicted not to collide during motion according to the planned track. Otherwise, if a collision detection result corresponding to a (one or more) timestamp among the plurality of timestamps indicates that the first movable device and the second movable device collide at the corresponding timestamp, the collision detection feedback result of the first movable device is generated. In this case, the collision detection feedback result indicates that the first movable device and the second movable device collide.

Further, after the air traffic management device obtains the collision detection feedback result of the first movable device, if the collision detection feedback result indicates that the first movable device may collide, some embodiments of the disclosure further supports feeding back a collision situation to the object holding the first movable device, so that the object may modify the track in time and autonomously determine whether to initiate a track application again. In a specific implementation, after determining that the collision detection feedback result of the first movable device indicates that the first movable device may collide, the air traffic management device may screen out a target timestamp corresponding to the collision detection result indicating occurrence of a collision from the plurality of timestamps within the first track time period, and generate correction prompt information based on the target timestamp. There is one or more target timestamps. Then, the air traffic management device outputs the correction prompt information to the first movable device, so that the object holding the first movable device may adjust the track based on the correction prompt information. Thus, the first movable device with an adjusted track does not collide with another second movable device that has applied for flight.

Specific content indicated by the correction prompt information generated by the air traffic management device is not limited in some embodiments of the disclosure. Illustratively, the correction prompt information may be configured for indicating, but is not limited to, one or more of the following: the first movable device colliding at the target timestamp, a collision component (or information for indicating a collision point such as a collision direction and a collision position) when the first movable device collides, and adjustment information (for example, a specific adjustment manner, so that after the object adjusts the track of the first movable device according to the adjustment information, the first movable device is predicted not to collide) for track information of the first movable device at the target timestamp.

In summary, in some embodiments of the disclosure, a construction logic of a three-layer three-dimensional spatial structure is creatively provided with reference to the physical size of the first movable device and the interference to the ambient environment. A corresponding first three-dimensional spatial structure is constructed for the first movable device at each timestamp, to ensure that the three-dimensional spatial structure subsequently used for collision detection can not only completely enclose the physical components of the entire first movable device, but also enclose an interference range of the interference signal generated by the first movable device to the ambient environment during operation, thereby greatly improving the safety of the first movable device during operation. In addition, adopting the elliptical cylinder to perform space collision and overlapping between different encapsulates in the conventional technology suffers from drawbacks such as a large calculation amount, a complex process, and a long time consumption. However, the air traffic management device has a relatively high timeliness requirement on collision detection of a plurality of pieces of to-be-detected track information submitted by a plurality of operators, typically demanding rapid determination of whether a collision will occur. In view of this, in some embodiments of the disclosure, a new collision detection policy is creatively provided with reference to the characteristics of the first three-dimensional spatial structure. The policy supports first performing collision detection using particle detection with simple calculation, and when the particle detection result indicates that a collision may occur, vertex collision detection is further introduced to implement more accurate collision detection. It can be seen that, in addition to ensuring the accuracy of collision detection, such a double-layer collision detection manner in some embodiments of the disclosure greatly improves the calculation efficiency of collision detection compared with conventional detection of hundreds or even thousands of times, and helps the air traffic management device implement collision detection of a plurality of to-be-detected tracks.

The foregoing describes the method in some embodiments of the disclosure in detail. For ease of better implementing the foregoing solutions in some embodiments of the disclosure, correspondingly, the following provides an apparatus in some embodiments of the disclosure. In some embodiments of the disclosure, the term “module” or “unit” refers to a computer program having a predetermined function or a part of the computer program, works together with other relevant parts to achieve a predetermined objective, and may be all or partially implemented through software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

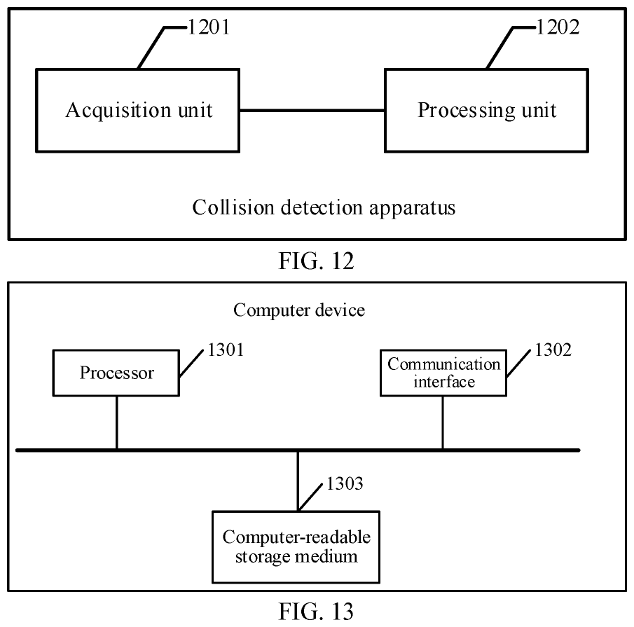

FIG. 12 is a schematic structural diagram of a collision detection apparatus according to an exemplary embodiment of the disclosure. The collision detection apparatus may be configured to perform all or some operations in the method embodiments shown in FIG. 2 and FIG. 8. Referring to FIG. 12, the apparatus includes the following units:
an acquisition unit 1201, configured to acquire to-be-detected track information of a first movable device, the to-be-detected track information including: a plurality of timestamps within a first track time period, position information of the first movable device at each of the timestamps, and physical size information of the first movable device; and
a processing unit 1202, configured to construct, for each of the timestamps, a first three-dimensional spatial structure corresponding to the timestamp based on the position information of the first movable device at the timestamp and the physical size information of the first movable device, the first three-dimensional spatial structure being a three-dimensional spatial structure constructed based on the physical size information of the first movable device, and an interference distance and an operating range of the first movable device at a timestamp corresponding to the first three-dimensional spatial structure.

The processing unit 1202 is further configured to acquire existing track information of a second movable device, collision detection of the second movable device being completed, and an obtained collision detection feedback result indicating that no collision is predicted to occur; the existing track information including: a plurality of timestamps within a second track time period of the second movable device and a second three-dimensional spatial structure corresponding to each of the timestamps; and the second three-dimensional spatial structure being a three-dimensional spatial structure constructed based on physical size information of the second movable device, and an interference distance and an operating range of the second movable device at a timestamp corresponding to the second three-dimensional spatial structure.

The processing unit 1202 is further configured to perform, using a collision detection policy, collision detection on the first three-dimensional spatial structure and the second three-dimensional spatial structure that correspond to a same timestamp, to obtain a collision detection result corresponding to the same timestamp.

The processing unit 1202 is further configured to generate a collision detection feedback result of the first movable device according to a collision detection result corresponding to each of the plurality of timestamps.

In an implementation, the to-be-detected track information further includes speed information and posture information of the first movable device at each of the timestamps; any timestamp among the plurality of timestamps within the first track time period is represented as a T^{th} timestamp; T is an integer greater than 0.

The processing unit 1202 is specifically configured to: during the construction, for each of the timestamps, of the first three-dimensional spatial structure corresponding to the timestamp based on the position information of the first movable device at the timestamp and the physical size information of the first movable device:
use the first movable device as a particle, and construct a core layer corresponding to the T^{th} timestamp according to position information and speed information of the particle at the T^{th} timestamp, and a first time period and a second time period that are adjacent to the T^{th} timestamp for the particle;
construct a physical layer corresponding to the T^{th} timestamp based on the core layer corresponding to the T^{th} timestamp, posture information of the first movable device at the T^{th} timestamp, and the physical size information of the first movable device; and
construct an interference layer corresponding to the T^{th} timestamp based on the physical layer and an interference distance of the first movable device to an ambient environment, the interference layer corresponding to the T^{th} timestamp being a first three-dimensional spatial structure corresponding to the first movable device at the T^{th} timestamp.

In an implementation, the interference layer contains the physical layer, and the physical layer contains the core layer.

The core layer is a three-dimensional spatial structure that, when the first movable device is used as the particle for track planning, is formed by all spatial positions that the first movable device is capable of reaching at the T^{th} timestamp.

The physical layer is a three-dimensional spatial structure that, when the first movable device moves to an edge of the core layer, is capable of enclosing an outer contour of the first movable device.

The interference layer is a three-dimensional spatial structure that, when the first movable device moves to the edge of the core layer, is capable of enclosing the interference distance by which the first movable device interferes with the ambient environment.

In an implementation, any timestamp among the plurality of timestamps within the first track time period is represented as the T^{th} timestamp. The processing unit 1202 is specifically configured to: during the performing, using the collision detection policy, of collision detection on the first three-dimensional spatial structure and the second three-dimensional spatial structure that correspond to the same timestamp, to obtain the collision detection result corresponding to the same timestamp,
perform particle collision detection on the position information of the first movable device at the T^{th} timestamp and position information of the second movable device at the T^{th} timestamp using the collision detection policy to obtain a particle detection result; and
perform, if the particle detection result indicates that distance information between the first movable device and the second movable device at the T^{th} timestamp is less than or equal to a preset distance threshold, vertex collision detection on a vertex of the first three-dimensional spatial structure corresponding to the T^{th} timestamp and a vertex of a second three-dimensional spatial structure corresponding to the T^{th} timestamp to obtain a collision detection result corresponding to the T^{th} timestamp.

The collision detection result corresponding to the T^{th} timestamp is configured for indicating that: the first movable device and the second movable device collide at the T^{th} timestamp, or do not collide at the T^{th} timestamp.

In an implementation, the position information is represented in a form of spatial coordinates, and the spatial coordinates include a first coordinate value, a second coordinate value, and a third coordinate value. The processing unit 1202 is specifically configured to: during the performing of particle collision detection on the position information of the first movable device at the T^{th} timestamp and position information of the second movable device at the T^{th} timestamp using the collision detection policy to obtain the particle detection result,
compare a first coordinate value of the first movable device at the T^{th} timestamp with a first coordinate value of the second movable device at the T^{th} timestamp using the collision detection policy to obtain a first comparison subresult corresponding to the first coordinate value;
compare a second coordinate value of the first movable device at the T^{th} timestamp with a second coordinate value of the second movable device at the T^{th} timestamp using the collision detection policy to obtain a second comparison subresult corresponding to the second coordinate value;
compare a third coordinate value of the first movable device at the T^{th} timestamp with a third coordinate value of the second movable device at the T^{th} timestamp using the collision detection policy to obtain a third comparison subresult corresponding to the third coordinate value; and
generate the particle detection result based on the first comparison subresult, the second comparison subresult, and the third comparison subresult.

In an implementation, each coordinate value in the spatial position corresponds to one preset distance threshold. The processing unit 1202 is specifically configured to: during the generation of the particle detection result based on the first comparison subresult, the second comparison subresult, and the third comparison subresult,
generate the particle detection result if any one of following cases is satisfied: the first comparison subresult is less than a preset distance threshold corresponding to the first coordinate value, the second comparison subresult is less than a preset distance threshold corresponding to the second coordinate value, or the third comparison subresult is less than a preset distance threshold corresponding to the third coordinate value, the particle detection result indicating that the first movable device and the second movable device collide at the T^{th} timestamp; or
generate the particle detection result if the first comparison subresult is greater than or equal to the preset distance threshold corresponding to the first coordinate value, the second comparison subresult is greater than or equal to the preset distance threshold corresponding to the second coordinate value, and the third comparison subresult is greater than or equal to the preset distance threshold corresponding to the third coordinate value, the particle detection result indicating that the first movable device and the second movable device are predicted not to collide at the T^{th} timestamp.

In an implementation, the to-be-detected track information of the first movable device further includes the posture information of the first movable device at the T^{th} timestamp. The processing unit 1202 is specifically configured to: during the performing of vertex collision detection on the vertex of the first three-dimensional spatial structure corresponding to the T^{th} timestamp and the vertex of the second three-dimensional spatial structure corresponding to the T^{th} timestamp to obtain the collision detection result corresponding to the T^{th} timestamp,
calculate vertex coordinates of an extremum vertex in the first three-dimensional spatial structure corresponding to the T^{th} timestamp according to the position information of the first movable device at the T^{th} timestamp, the physical size information of the first movable device, and the posture information of the first movable device at the T^{th} timestamp;
acquire vertex coordinates of an extremum vertex in the second three-dimensional spatial structure corresponding to the second movable device at the T^{th} timestamp; and
calculate the vertex coordinates of the extremum vertex in the first three-dimensional spatial structure corresponding to the first movable device at the T^{th} timestamp and the vertex coordinates of the extremum vertex in the second three-dimensional spatial structure corresponding to the second movable device at the T^{th} timestamp using an extremum check rule to obtain the collision detection result corresponding to the T^{th} timestamp.

In an implementation, the extremum vertex of the first three-dimensional spatial structure refers to a vertex whose spatial coordinates are extreme values among a plurality of vertexes included in the first three-dimensional spatial structure. The extremum vertex of the second three-dimensional spatial structure refers to a vertex whose spatial coordinates are extreme values among a plurality of vertexes included in the second three-dimensional spatial structure.

The extremum check rule includes a plurality of determining formulas; when each of the plurality of determining formulas is true, the collision detection result corresponding to the T^{th} timestamp indicates that the first movable device and the second movable device collide at the T^{th} timestamp; when at least one of the plurality of determining formulas is false, the collision detection result corresponding to the T^{th} timestamp indicates that the first movable device and the second movable device are predicted not to collide at the T^{th} timestamp.

In an implementation, the processing unit 1202 is further configured to:

obtain the collision detection result corresponding to the T^{th} timestamp if the particle detection result indicates that the distance information between the first movable device and the second movable device at the T^{th} timestamp is greater than the preset distance threshold, the collision detection result corresponding to the T^{th} timestamp indicating that the first movable device and the second movable device are predicted not to collide at the T^{th} timestamp.

In an implementation, the processing unit 1202 is specifically configured to: during the generation of the collision detection feedback result of the first movable device according to the collision detection result corresponding to each of the plurality of timestamps,

generate the collision detection feedback result of the first movable device if a collision detection result corresponding to a timestamp among the plurality of timestamps indicates that the first movable device and the second movable device collide at a corresponding timestamp, the collision detection feedback result indicating that the first movable device and the second movable device collide.

The processing unit 1202 is further configured to:

screen out a target timestamp corresponding to the collision detection result indicating occurrence of a collision from the plurality of timestamps, and generate correction prompt information based on the target timestamp; and output the correction prompt information to the first movable device.

In an implementation, the first movable device or the second movable device includes any one of the following: an aircraft, an intelligent robot, a vehicle, or a ship.

According to some embodiments of the disclosure, the units in the collision detection apparatus shown in FIG. 12 may be separately or wholly combined into one or several other units, or one (or more) of the units may further be divided into a plurality of units having smaller functions. In this way, same operations may be implemented, and the implementation of the technical effects of some embodiments of the disclosure is not affected. The foregoing units are divided based on logical functions. In practical application, a function of one unit may further be implemented by a plurality of units, or functions of a plurality of units are implemented by one unit. In other embodiments of the disclosure, the collision detection apparatus may further include other units. In practical application, these functions may alternatively be cooperatively implemented by other units, and may be cooperatively implemented by a plurality of units. According to another embodiment of the disclosure, a computer program (including program code) that can perform the operations in the corresponding method shown in FIG. 2 and FIG. 8 may be run on a general-purpose computing device, such as a computer, which includes processing elements and storage elements such as a central processing unit (CPU), a random access memory (RAM), and a read-only memory (ROM), to construct the collision detection apparatus shown in FIG. 12 and implement the collision detection method in some embodiments of the disclosure. The computer program may be recorded in, for example, a computer-readable recording medium, and may be loaded into the foregoing computing device through the computer-readable recording medium and run on the computing device.

In some embodiments of the disclosure, a brand new collision detection solution for a movable device is provided. The physical size of the movable device and the surrounding interference during the motion of the movable device are fully considered, to construct corresponding first three-dimensional spatial structures for the movable device at different timestamps. Compared with performing collision detection using the first movable device as a particle, the accuracy of collision detection can be improved based on the first three-dimensional spatial structure containing the physical size and the interference distance. In addition, a new collision detection policy is designed to perform collision detection on the first three-dimensional spatial structure corresponding to the first movable device and the second three-dimensional spatial structure corresponding to the second movable device. Compared with the conventional detection method, the number of times of detection is effectively reduced, thereby improving the efficiency of collision detection.

FIG. 13 is a schematic structural diagram of a computer device according to some embodiments of the disclosure. Referring to FIG. 13, the computer device includes a processor 1301, a communication interface 1302, and a computer-readable storage medium 1303. The processor 1301, the communication interface 1302, and the computer-readable storage medium 1303 may be connected through a bus or in another manner. The communication interface 1302 is configured to receive and transmit data. The computer-readable storage medium 1303 may be stored in a memory of an electronic device. The computer-readable storage medium 1303 is configured to store a computer program. The computer program includes program instructions. The processor 1301 is configured to execute the program instructions stored in the computer-readable storage medium 1303. The processor 1301 (alternatively referred to as a CPU), as a computing core and a control core of the computer device, is adapted to implementing one or more instructions, specifically adapted to loading and executing the one or more instructions to implement corresponding method procedures or corresponding functions.

Some embodiments of the disclosure further provide a computer-readable storage medium (memory). The computer-readable storage medium is a memory device in a computer device, and is configured to store a program and data. The computer-readable storage medium herein may include both a built-in storage medium of the computer device and an extended storage medium supported by the computer device. The computer-readable storage medium provides a storage space for storing a processing system of the computer device. In addition, one or more instructions adapted to being loaded and executed by the processor 1301 are further stored in the storage space, and these instructions may be one or more computer programs (including program code). The computer-readable storage medium herein may be a high-speed RAM, or may be a non-volatile memory, for example, at least one magnetic disk memory. In some embodiments, it may alternatively be at least one computer-readable storage medium located far away from the foregoing processor.

In some embodiments, the computer-readable storage medium has one or more instructions stored therein. The one or more instructions stored in the computer-readable storage medium are loaded and executed by the processor 1301 to implement corresponding operations in the foregoing collision detection method embodiments. In a specific implementation, the one or more instructions in the computer-readable storage medium are loaded by the processor 1301 to perform the following operations:
acquiring to-be-detected track information of a first movable device, the to-be-detected track information including: a plurality of timestamps within a first track time period, position information of the first movable device at each of the timestamps, and physical size information of the first movable device;
constructing, for each of the timestamps, a first three-dimensional spatial structure corresponding to the timestamp based on the position information of the first movable device at the timestamp and the physical size information of the first movable device, the first three-dimensional spatial structure being a three-dimensional spatial structure constructed based on the physical size information of the first movable device, and an interference distance and an operating range of the first movable device at a timestamp corresponding to the first three-dimensional spatial structure;
acquiring existing track information of a second movable device, collision detection of the second movable device being completed, and an obtained collision detection feedback result indicating that no collision is predicted to occur; the existing track information including: a plurality of timestamps within a second track time period of the second movable device and a second three-dimensional spatial structure corresponding to each of the timestamps; and the second three-dimensional spatial structure being a three-dimensional spatial structure constructed based on physical size information of the second movable device, and an interference distance and an operating range of the second movable device at a timestamp corresponding to the second three-dimensional spatial structure;
performing, using a collision detection policy, collision detection on the first three-dimensional spatial structure and the second three-dimensional spatial structure that correspond to a same timestamp, to obtain a collision detection result corresponding to the same timestamp; and
generating a collision detection feedback result of the first movable device according to a collision detection result corresponding to each of the plurality of timestamps.

In an implementation, the to-be-detected track information further includes speed information and posture information of the first movable device at each of the timestamps; any timestamp among the plurality of timestamps within the first track time period is represented as a T^{th} timestamp; T is an integer greater than 0.

The one or more instructions in the computer-readable storage medium are loaded by the processor 1301, and when constructing, for each of the timestamps, a first three-dimensional spatial structure corresponding to the timestamp based on the position information of the first movable device at the timestamp and the physical size information of the first movable device, the following operations are specifically performed:
using the first movable device as a particle, and constructing a core layer corresponding to the T^{th} timestamp according to position information and speed information of the particle at the T^{th} timestamp, and a first time period and a second time period that are adjacent to the T^{th} timestamp for the particle;
constructing a physical layer corresponding to the T^{th} timestamp based on the core layer corresponding to the T^{th} timestamp, posture information of the first movable device at the T^{th} timestamp, and the physical size information of the first movable device; and
constructing an interference layer corresponding to the T^{th} timestamp based on the physical layer and an interference distance of the first movable device to an ambient environment, the interference layer corresponding to the T^{th} timestamp being a first three-dimensional spatial structure corresponding to the first movable device at the T^{th} timestamp.

In an implementation, the interference layer contains the physical layer, and the physical layer contains the core layer.

The core layer is a three-dimensional spatial structure that, when the first movable device is used as the particle for track planning, is formed by all spatial positions that the first movable device is capable of reaching at the T^{th} timestamp.

The physical layer is a three-dimensional spatial structure that, when the first movable device moves to an edge of the core layer, is capable of enclosing an outer contour of the first movable device.

The interference layer is a three-dimensional spatial structure that, when the first movable device moves to the edge of the core layer, is capable of enclosing the interference distance by which the first movable device interferes with the ambient environment.

In an implementation, any timestamp among the plurality of timestamps within the first track time period is represented as the T^{th} timestamp. The one or more instructions in the computer-readable storage medium are loaded by the processor 1301, and when performing, using a collision detection policy, collision detection on the first three-dimensional spatial structure and the second three-dimensional spatial structure that correspond to a same timestamp, to obtain a collision detection result corresponding to the same timestamp, the following operations are specifically performed:
performing particle collision detection on the position information of the first movable device at the T^{th} timestamp and position information of the second movable device at the T^{th} timestamp using the collision detection policy to obtain a particle detection result; and
performing, if the particle detection result indicates that distance information between the first movable device and the second movable device at the T^{th} timestamp is less than or equal to a preset distance threshold, vertex collision detection on a vertex of the first three-dimensional spatial structure corresponding to the T^{th} timestamp and a vertex of a second three-dimensional spatial structure corresponding to the T^{th} timestamp to obtain a collision detection result corresponding to the T^{th} timestamp.

The collision detection result corresponding to the T^{th} timestamp is configured for indicating that: the first movable device and the second movable device collide at the T^{th} timestamp, or do not collide at the T^{th} timestamp.

In an implementation, the position information is represented in a form of spatial coordinates, and the spatial coordinates include a first coordinate value, a second coordinate value, and a third coordinate value. The one or more instructions in the computer-readable storage medium are loaded by the processor 1301, and when performing particle collision detection on the position information of the first movable device at the T^{th} timestamp and position information of the second movable device at the T^{th} timestamp using the collision detection policy to obtain a particle detection result, the following operations are specifically performed:
comparing a first coordinate value of the first movable device at the T^{th} timestamp with a first coordinate value of the second movable device at the T^{th} timestamp using the collision detection policy to obtain a first comparison subresult corresponding to the first coordinate value;
comparing a second coordinate value of the first movable device at the T^{th} timestamp with a second coordinate value of the second movable device at the T^{th} timestamp using the collision detection policy to obtain a second comparison subresult corresponding to the second coordinate value;
comparing a third coordinate value of the first movable device at the T^{th} timestamp with a third coordinate value of the second movable device at the T^{th} timestamp using the collision detection policy to obtain a third comparison subresult corresponding to the third coordinate value; and
generating the particle detection result based on the first comparison subresult, the second comparison subresult, and the third comparison subresult.

In an implementation, each coordinate value in the spatial position corresponds to one preset distance threshold. The one or more instructions in the computer-readable storage medium are loaded by the processor 1301, and when generating the particle detection result based on the first comparison subresult, the second comparison subresult, and the third comparison subresult, the following operations are specifically performed:
generating the particle detection result if any one of following cases is satisfied: the first comparison subresult is less than a preset distance threshold corresponding to the first coordinate value, the second comparison subresult is less than a preset distance threshold corresponding to the second coordinate value, or the third comparison subresult is less than a preset distance threshold corresponding to the third coordinate value, the particle detection result indicating that the first movable device and the second movable device collide at the T^{th} timestamp; or
generating the particle detection result if the first comparison subresult is greater than or equal to the preset distance threshold corresponding to the first coordinate value, the second comparison subresult is greater than or equal to the preset distance threshold corresponding to the second coordinate value, and the third comparison subresult is greater than or equal to the preset distance threshold corresponding to the third coordinate value, the particle detection result indicating that the first movable device and the second movable device are predicted not to collide at the T^{th} timestamp.

In an implementation, the to-be-detected track information of the first movable device further includes the posture information of the first movable device at the T^{th} timestamp. The one or more instructions in the computer-readable storage medium are loaded by the processor 1301, and when performing vertex collision detection on a vertex of the first three-dimensional spatial structure corresponding to the T^{th} timestamp and a vertex of a second three-dimensional spatial structure corresponding to the T^{th} timestamp to obtain a collision detection result corresponding to the T^{th} timestamp, the following operations are specifically performed:
calculating vertex coordinates of an extremum vertex in the first three-dimensional spatial structure corresponding to the T^{th} timestamp according to the position information of the first movable device at the T^{th} timestamp, the physical size information of the first movable device, and the posture information of the first movable device at the T^{th} timestamp;
acquiring vertex coordinates of an extremum vertex in the second three-dimensional spatial structure corresponding to the second movable device at the T^{th} timestamp; and
calculating the vertex coordinates of the extremum vertex in the first three-dimensional spatial structure corresponding to the first movable device at the T^{th} timestamp and the vertex coordinates of the extremum vertex in the second three-dimensional spatial structure corresponding to the second movable device at the T^{th} timestamp using an extremum check rule to obtain the collision detection result corresponding to the T^{th} timestamp.

In an implementation, the extremum vertex of the first three-dimensional spatial structure refers to a vertex whose spatial coordinates are extreme values among a plurality of vertexes included in the first three-dimensional spatial structure. The extremum vertex of the second three-dimensional spatial structure refers to a vertex whose spatial coordinates are extreme values among a plurality of vertexes included in the second three-dimensional spatial structure.

The extremum check rule includes a plurality of determining formulas; when each of the plurality of determining formulas is true, the collision detection result corresponding to the T^{th} timestamp indicates that the first movable device and the second movable device collide at the T^{th} timestamp; when at least one of the plurality of determining formulas is false, the collision detection result corresponding to the T^{th} timestamp indicates that the first movable device and the second movable device are predicted not to collide at the T^{th} timestamp.

In an implementation, the one or more instructions in the computer-readable storage medium are loaded by the processor 1301, and the following operations are performed:

obtaining the collision detection result corresponding to the T^{th} timestamp if the particle detection result indicates that the distance information between the first movable device and the second movable device at the T^{th} timestamp is greater than the preset distance threshold, the collision detection result corresponding to the T^{th} timestamp indicating that the first movable device and the second movable device are predicted not to collide at the T^{th} timestamp.

In an implementation, the one or more instructions in the computer-readable storage medium are loaded by the processor 1301, and when generating a collision detection feedback result of the first movable device according to a collision detection result corresponding to each of the plurality of timestamps, the following operations are specifically performed:

generating the collision detection feedback result of the first movable device if a collision detection result corresponding to a timestamp among the plurality of timestamps indicates that the first movable device and the second movable device collide at a corresponding timestamp, the collision detection feedback result indicating that the first movable device and the second movable device collide.

The one or more instructions in the computer-readable storage medium are loaded by the processor 1301, and the following operations are performed:

screening out a target timestamp corresponding to the collision detection result indicating occurrence of a collision from the plurality of timestamps, and generating correction prompt information based on the target timestamp; and outputting the correction prompt information to the first movable device.

In an implementation, the first movable device or the second movable device includes any one of the following: an aircraft, an intelligent robot, a vehicle, or a ship.

Based on the same inventive concept, the problem-solving principle and beneficial effects of the computer device provided in some embodiments of the disclosure are similar to those of the collision detection method in the method embodiments of the disclosure, and may refer to the principle and beneficial effects of the implementation of the method. For brevity, details are not described herein again.

Some embodiments of the disclosure further provide a computer program product or a computer program, including computer instructions. The computer instructions are stored in a computer-readable storage medium. A processor of a computer device reads the computer instructions from the computer-readable storage medium and executes the computer instructions to cause the computer device to perform the foregoing collision detection method.

A person skilled in the art may recognize that the exemplary units and algorithm operations described with reference to some embodiments disclosed in the disclosure may be implemented in electronic hardware or in a combination of computer software and electronic hardware. Whether these functions are implemented in hardware or software depends on the specific application and design constraints of the technical solutions. For each particular application, a person skilled in the art may use different methods to achieve the described function, but this implementation shall not be considered beyond the scope of the disclosure.

In the foregoing embodiments, it may be partially or completely implemented through software, hardware, firmware, or any combination thereof. When implemented using software, the entire or part of the implementation may be in the form of the computer program product. The computer program product includes one or more computer instructions.

When the computer program instructions are loaded and executed on a computer, all or some of the procedures or functions according to some embodiments of the disclosure are generated. The computer may be a general-purpose computer, a special-purpose computer, a computer network, or another programmable device. The computer instructions may be stored in a computer-readable storage medium or transmitted through the computer-readable storage medium. The computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any available medium that can be accessed by the computer, or may be a data processing device such as a server or a data center integrated by one or more available media. The available medium may be a magnetic medium (for example, a floppy disk, a hard disk, or a magnetic tape), an optical medium (for example, a digital video disc (DVD)), a semiconductor medium (for example, a solid state disk (SSD)), or the like.

Technical features of the foregoing embodiments may be combined in different manners to form other embodiments. To make description concise, not all possible combinations of the technical features in the foregoing embodiments are described. However, as long as no conflict exists, the combinations of these technical features shall be considered as falling within the scope of the disclosure.

The foregoing embodiments express only several implementations of the disclosure, which are described in a relatively specific and detailed manner, but are not to be construed as a limitation of the patent scope. For a person skilled in the art, several transformations and improvements may be made without departing from the idea of the disclosure. These transformations and improvements belong to the protection scope of the disclosure. Therefore, the protection scope of the patent of the disclosure shall be subject to the appended claims.

What is claimed is:

1. A collision detection method, performed by a computer device, and comprising:
acquiring track information of a first movable device, the track information including: a first plurality of timestamps within a first track time period of the first movable device, position information of the first movable device at each of the first plurality of timestamps, and physical size information of the first movable device;
constructing, for each of the first plurality of timestamps, a first three-dimensional spatial structure corresponding to the respective timestamp based on the position information of the first movable device at the respective timestamp and the physical size information of the first movable device;
acquiring existing track information of a second movable device based on collision detection of the second moveable device being completed to indicate that no collision is predicted to occur, the existing track information including:
a second plurality of timestamps within a second track time period of the second movable device; and
a second three-dimensional spatial structure corresponding to each of the second plurality of timestamps, the second three-dimensional spatial structure being a three-dimensional spatial structure constructed based on physical size information of the second movable device, and an interference distance and an operating range of the second movable device at a timestamp corresponding to the second three-dimensional spatial structure;
performing, using a collision detection policy, collision detection based on the first three-dimensional spatial structure and the second three-dimensional spatial structure that correspond to a same timestamp, to obtain a collision detection result corresponding to the same timestamp; and
generating a collision detection feedback result of the first movable device based on a collision detection result corresponding to each of the first plurality of timestamps.

2. The collision detection method according to claim 1, wherein the track information further includes speed information and posture information of the first movable device at each of the first plurality of timestamps, a T^{th} timestamp representing one of the first plurality of timestamps within the first track time period, T being an integer greater than 0, and
wherein the constructing, for each of the first plurality of timestamps, a first three-dimensional spatial structure corresponding to the respective timestamp based on the position information of the first movable device at the respective timestamp and the physical size information of the first movable device comprises:
using the first movable device as a particle;
constructing a core layer corresponding to the T^{th} timestamp based on the position information and the speed information of the particle at the T^{th} timestamp, and a first time period and a second time period that are adjacent to the T^{th} timestamp for the particle;
constructing a physical layer corresponding to the T^{th} timestamp based on the core layer corresponding to the T^{th} timestamp, posture information of the first movable device at the T^{th} timestamp, and the physical size information of the first movable device; and
constructing an interference layer corresponding to the T^{th} timestamp based on the physical layer and an interference distance of the first movable device to an ambient environment, the interference layer corresponding to the T^{th} timestamp being a first three-dimensional spatial structure corresponding to the first movable device at the T^{th} timestamp.

3. The collision detection method according to claim 2, wherein the interference layer includes the physical layer, and the physical layer includes the core layer,
wherein the core layer corresponds to a three-dimensional spatial structure that includes spatial positions that the first movable device is reachable at the T^{th} timestamp based on the first movable device being used as the particle for track planning,
wherein the physical layer corresponds to a three-dimensional spatial structure that encloses an outer contour of the first movable device based on the first movable device moving to an edge of the core layer, and
wherein the interference layer corresponds to a three-dimensional spatial structure that encloses the interference distance by which the first movable device interferes with the ambient environment based on the first movable device moving to the edge of the core layer.

4. The collision detection method according to claim 1, wherein a T^{th} timestamp represents one of the first plurality of timestamps within the first track time period,
wherein the performing, using a collision detection policy, collision detection on the first three-dimensional spatial structure and the second three-dimensional spatial structure that correspond to the same timestamp, to obtain the collision detection result corresponding to the same timestamp comprises:
performing, using the collision detection policy, particle collision detection based on the position information of the first movable device at the T^{th} timestamp and position information of the second movable device at the T^{th} timestamp, to obtain a particle detection result; and
performing, when the particle detection result indicates that distance information between the first movable device and the second movable device at the T^{th} timestamp is less than or equal to a preset distance threshold, vertex collision detection based on a vertex of the first three-dimensional spatial structure corresponding to the T^{th} timestamp and a vertex of a second three-dimensional spatial structure corresponding to the T^{th} timestamp, to obtain a collision detection result corresponding to the T^{th} timestamp, and
wherein the collision detection result corresponding to the T^{th} timestamp indicates whether the first movable device and the second movable device collide at the T^{th} timestamp.

5. The collision detection method according to claim 4, wherein the position information is represented as spatial coordinates comprising first coordinate values, second coordinate values, and third coordinate values, and
wherein the performing particle collision detection on the position information of the first movable device at the T^{th} timestamp and position information of the second movable device at the T^{th} timestamp using the collision detection policy to obtain the particle detection result comprises:
comparing a first coordinate value of the first movable device at the T^{th} timestamp with a first coordinate value of the second movable device at the T^{th} timestamp using the collision detection policy, to obtain a first comparison subresult corresponding to the first coordinate values;
comparing a second coordinate value of the first movable device at the T^{th} timestamp with a second coordinate value of the second movable device at the T^{th} timestamp using the collision detection policy, to obtain a second comparison subresult corresponding to the second coordinate values;
comparing a third coordinate value of the first movable device at the T^{th} timestamp with a third coordinate value of the second movable device at the T^{th} timestamp using the collision detection policy, to obtain a third comparison subresult corresponding to the third coordinate values; and
generating the particle detection result based on the first comparison subresult, the second comparison subresult, and the third comparison subresult.

6. The collision detection method according to claim 5, wherein each coordinate value in the spatial position corresponds to the preset distance threshold, and
wherein the generating the particle detection result based on the first comparison subresult, the second comparison subresult, and the third comparison subresult comprises:
generating the particle detection result based on at least one of:
the first comparison subresult being less than a preset distance threshold corresponding to the first coordinate value;
the second comparison subresult being less than a preset distance threshold corresponding to the second coordinate value, or the third comparison subresult is less than a preset distance threshold corresponding to the third coordinate value; or
the particle detection result indicating that the first movable device and the second movable device collide at the T^{th} timestamp.

7. The collision detection method according to claim 5, wherein the generating the particle detection result based on the first comparison subresult, the second comparison subresult, and the third comparison subresult comprises:
generating the particle detection result based on:
the first comparison subresult being greater than or equal to the preset distance threshold corresponding to the first coordinate value;
the second comparison subresult being greater than or equal to the preset distance threshold corresponding to the second coordinate value; and
the third comparison subresult being greater than or equal to the preset distance threshold corresponding to the third coordinate value, and
wherein the particle detection result indicates that the first movable device and the second movable device are predicted not to collide at the T^{th} timestamp.

8. The collision detection method according to claim 4, wherein the track information of the first movable device further includes the posture information of the first movable device at the T^{th} timestamp, and
wherein the performing vertex collision detection based on the vertex of the first three-dimensional spatial structure corresponding to the T^{th} timestamp and the vertex of a second three-dimensional spatial structure corresponding to the T^{th} timestamp, to obtain the collision detection result corresponding to the T^{th} timestamp comprises:
calculating vertex coordinates of an extremum vertex in the first three-dimensional spatial structure corresponding to the T^{th} timestamp based on the position information of the first movable device at the T^{th} timestamp, the physical size information of the first movable device, and the posture information of the first movable device at the T^{th} timestamp;
acquiring vertex coordinates of an extremum vertex in the second three-dimensional spatial structure corresponding to the second movable device at the T^{th} timestamp; and
calculating the vertex coordinates of the extremum vertex in the first three-dimensional spatial structure corresponding to the first movable device at the T^{th} timestamp and the vertex coordinates of the extremum vertex in the second three-dimensional spatial structure corresponding to the second movable device at the T^{th} timestamp using an extremum check rule, to obtain the collision detection result corresponding to the T^{th} timestamp.

9. The collision detection method according to claim 8, wherein the extremum vertex of the first three-dimensional spatial structure corresponds to a vertex whose spatial coordinates are extreme values among a plurality of vertexes included in the first three-dimensional spatial structure,
wherein the extremum vertex of the second three-dimensional spatial structure corresponds to a vertex whose spatial coordinates are extreme values among a plurality of vertexes included in the second three-dimensional spatial structure,
wherein the extremum check rule includes a plurality of determining formulas, wherein the collision detection result corresponding to the T^{th} timestamp indicates that the first movable device and the second movable device collide at the T^{th} timestamp based on each of the plurality of determining formulas being satisfied, and
wherein the collision detection result corresponding to the T^{th} timestamp indicates that the first movable device and the second movable device are predicted not to collide at the T^{th} timestamp based on at least one of the plurality of determining formulas being unsatisfied.

10. The collision detection method according to claim 4, further comprising:
obtaining the collision detection result corresponding to the T^{th} timestamp based on the particle detection result indicating that the distance information between the first movable device and the second movable device at the T^{th} timestamp is greater than the preset distance threshold, the collision detection result corresponding to the T^{th} timestamp indicating that the first movable device and the second movable device are predicted not to collide at the T^{th} timestamp.

11. The collision detection method according to claim 1, wherein the generating the collision detection feedback result of the first movable device based on the collision detection result corresponding to each of the first plurality of timestamps comprises:
generating the collision detection feedback result of the first movable device based on a collision detection result corresponding to a timestamp among the first plurality of timestamps indicating that the first movable device and the second movable device collide at a corresponding timestamp, the collision detection feedback result indicating that the first movable device and the second movable device collide, and
wherein the collision detection method further comprises:
screening out a target timestamp corresponding to the collision detection result indicating occurrence of a collision from the first plurality of timestamps;
generating correction prompt information based on the target timestamp; and
outputting the correction prompt information to the first movable device.

12. The collision detection method according to claim 1, wherein the first movable device or the second movable device includes at least one of: an aircraft, an intelligent robot, a vehicle, or a ship.

13. A collision detection apparatus, comprising:
at least one memory configured to store computer program code; and
at least one processor configured to read the program code and operate as instructed by the program code, the program code comprising:
acquisition code configured to cause the at least one processor to acquire track information of a first movable device, the track information including: a first plurality of timestamps within a first track time period of the first movable device, position information of the first movable device at each of the first plurality of timestamps, and physical size information of the first movable device; and
processing code configured to cause the at least one processor to:
construct, for each of the first plurality of timestamps, a first three-dimensional spatial structure corresponding to the respective timestamp based on the position information of the first movable device at the respective timestamp and the physical size information of the first movable device;
acquire existing track information of a second movable device based on collision detection of the second moveable device being completed to indicate that no collision is predicted to occur, the existing track information including:
a second plurality of timestamps within a second track time period of the second movable device; and
a second three-dimensional spatial structure corresponding to each of the second plurality of timestamps, the second three-dimensional spatial structure being a three-dimensional spatial structure constructed based on physical size information of the second movable device, and an interference distance and an operating range of the second movable device at a timestamp corresponding to the second three-dimensional spatial structure;
perform, using a collision detection policy, collision detection based on the first three-dimensional spatial structure and the second three-dimensional spatial structure that correspond to a same timestamp, to obtain a collision detection result corresponding to the same timestamp; and
generate a collision detection feedback result of the first movable device based on a collision detection result corresponding to each of the first plurality of timestamps.

14. The collision detection apparatus of claim 13, wherein the track information further includes speed information and posture information of the first movable device at each of the first plurality of timestamps, a T^{th} timestamp representing one of the first plurality of timestamps within the first track time period, T being an integer greater than 0, and
wherein the processing code is further configured to cause the at least one processor to:
use the first movable device as a particle;
construct a core layer corresponding to the T^{th} timestamp based on the position information and the speed information of the particle at the T^{th} timestamp, and a first time period and a second time period that are adjacent to the T^{th} timestamp for the particle;
construct a physical layer corresponding to the T^{th} timestamp based on the core layer corresponding to the T^{th} timestamp, posture information of the first movable device at the T^{th} timestamp, and the physical size information of the first movable device; and
construct an interference layer corresponding to the T^{th} timestamp based on the physical layer and an interference distance of the first movable device to an ambient environment, the interference layer corresponding to the T^{th} timestamp being a first three-dimensional spatial structure corresponding to the first movable device at the T^{th} timestamp.

15. The collision detection apparatus of claim 13, wherein a T^{th} timestamp represents one of the plurality of timestamps within the first track time period,
wherein the processing code is further configured to cause the at least one processor to:
perform, using the collision detection policy, particle collision detection based on the position information of the first movable device at the T^{th} timestamp and position information of the second movable device at the T^{th} timestamp, to obtain a particle detection result; and
perform, when the particle detection result indicates that distance information between the first movable device and the second movable device at the T^{th} timestamp is less than or equal to a preset distance threshold, vertex collision detection based on a vertex of the first three-dimensional spatial structure corresponding to the T^{th} timestamp and a vertex of a second three-dimensional spatial structure corresponding to the T^{th} timestamp, to obtain a collision detection result corresponding to the T^{th} timestamp, and
wherein the collision detection result corresponding to the T^{th} timestamp indicates whether the first movable device and the second movable device collide at the T^{th} timestamp.

16. The collision detection apparatus of claim 15, wherein the position information is represented as spatial coordinates comprising first coordinate values, second coordinate values, and third coordinate values, and
wherein the processing code is further configured to cause the at least one processor to:
compare a first coordinate value of the first movable device at the T^{th} timestamp with a first coordinate value of the second movable device at the T^{th} timestamp using the collision detection policy, to obtain a first comparison subresult corresponding to the first coordinate values;
compare a second coordinate value of the first movable device at the T^{th} timestamp with a second coordinate value of the second movable device at the T^{th} timestamp using the collision detection policy, to obtain a second comparison subresult corresponding to the second coordinate values;
compare a third coordinate value of the first movable device at the T^{th} timestamp with a third coordinate value of the second movable device at the T^{th} timestamp using the collision detection policy, to obtain a third comparison subresult corresponding to the third coordinate values; and
generate the particle detection result based on the first comparison subresult, the second comparison subresult, and the third comparison subresult.

17. The collision detection apparatus of claim 16, wherein each coordinate value in the spatial position corresponds to the preset distance threshold, and
wherein the processing code is further configured to cause the at least one processor to:
generate the particle detection result based on at least one of:
the first comparison subresult being less than a preset distance threshold corresponding to the first coordinate value;
the second comparison subresult being less than a preset distance threshold corresponding to the second coordinate value, or the third comparison subresult is less than a preset distance threshold corresponding to the third coordinate value; or
the particle detection result indicating that the first movable device and the second movable device collide at the T^{th} timestamp.

18. The collision detection apparatus of claim 16, wherein processing code is further configured to cause the at least one processor to:
generating the particle detection result based on:
the first comparison subresult being greater than or equal to the preset distance threshold corresponding to the first coordinate value;
the second comparison subresult being greater than or equal to the preset distance threshold corresponding to the second coordinate value; and
the third comparison subresult being greater than or equal to the preset distance threshold corresponding to the third coordinate value, and
wherein the particle detection result indicates that the first movable device and the second movable device are predicted not to collide at the T^{th} timestamp.

19. The collision detection apparatus of claim 15, wherein the track information of the first movable device further includes the posture information of the first movable device at the T^{th} timestamp, and
wherein processing code is further configured to cause the at least one processor to:
calculate vertex coordinates of an extremum vertex in the first three-dimensional spatial structure corresponding to the T^{th} timestamp based on the position information of the first movable device at the T^{th} timestamp, the physical size information of the first movable device, and the posture information of the first movable device at the T^{th} timestamp;
acquire vertex coordinates of an extremum vertex in the second three-dimensional spatial structure corresponding to the second movable device at the T^{th} timestamp; and
calculate the vertex coordinates of the extremum vertex in the first three-dimensional spatial structure corresponding to the first movable device at the T^{th} timestamp and the vertex coordinates of the extremum vertex in the second three-dimensional spatial structure corresponding to the second movable device at the T^{th} timestamp using an extremum check rule, to obtain the collision detection result corresponding to the T^{th} timestamp.

20. The non-transitory computer-readable storage medium, storing computer code, when executed by at least one processor, causes the at least one processor to at least:
acquire track information of a first movable device, the track information including: a first plurality of timestamps within a first track time period of the first movable device, position information of the first movable device at each of the first plurality of timestamps, and physical size information of the first movable device;
construct, for each of the first plurality of timestamps, a first three-dimensional spatial structure corresponding to the respective timestamp based on the position information of the first movable device at the respective timestamp and the physical size information of the first movable device;
acquire existing track information of a second movable device based on collision detection of the second moveable device being completed to indicate that no collision is predicted to occur, the existing track information including:
a second plurality of timestamps within a second track time period of the second movable device; and
a second three-dimensional spatial structure corresponding to each of the second plurality of timestamps, the second three-dimensional spatial structure being a three-dimensional spatial structure constructed based on physical size information of the second movable device, and an interference distance and an operating range of the second movable device at a timestamp corresponding to the second three-dimensional spatial structure;
perform, using a collision detection policy, collision detection based on the first three-dimensional spatial structure and the second three-dimensional spatial structure that correspond to a same timestamp, to obtain a collision detection result corresponding to the same timestamp; and
generate a collision detection feedback result of the first movable device based on a collision detection result corresponding to each of the first plurality of timestamps.
